(19) United States
(12) Patent Application Publication
(10) Pub. No.: US 2025/0314817 A1
(43) Pub. Date: Oct. 9, 2025

(54) OPTICAL FIBERS WITH NON-CIRCULAR COATING

(71) Applicant: CORNING INCORPORATED, CORNING, NY (US)

(72) Inventors: Arash Abedijaberi, Hsinchu City (TW); Kevin Wallace Bennett, Hammondsport, NY (US); Douglas Llewellyn Butler, Painted Post, NY (US); Ilia Andreyevich Nikulin, Leland, NC (US); James Scott Sutherland, Painted Post, NY (US)

(21) Appl. No.: 19/087,935

(22) Filed: Mar. 24, 2025

Related U.S. Application Data
(60) Provisional application No. 63/631,711, filed on Apr. 9, 2024.

(51) Int. Cl. G02B 6/02

(52) U.S. Cl. CPC G02B 6/02338; G02B 6/02371

(57) ABSTRACT

A non-circular optical fiber comprises: a glass cladding having a cross-sectional profile, where the cross-sectional profile is non-circular and includes an alignment region having formation bulges, and where an alignment axis is defined by the formation bulges; a core arrangement including at least one glass core; and a coating coupled to and in direct contact with the glass cladding, where the coating defines an alignment plane along the alignment region of the glass cladding, and where an angle between the alignment plane and the alignment axis is less than or equal to about 15°.

### CROSS-REFERENCE TO RELATED APPLICATIONS

This application claims the benefit of priority under 35 U.S.C. § 119 of U.S. Provisional Application Ser. No. 63/631,711 filed on Apr. 9, 2024, the content of which is relied upon and incorporated herein by reference in its entirety.

### FIELD OF THE DISCLOSURE

The present disclosure generally relates to optical fibers. More specifically, the present disclosure relates to optical fiber with non-circular coatings and methods of manufacturing the same.

### BACKGROUND

Optical fibers are utilized in a variety of telecommunication applications. Coupling optical fiber together to extend the length of the optical fibers allows for communication pathways to be established over longer distances. Optical fibers also formed into ribbons that include multiple optical fibers to form multiple communication pathways. In order to couple ribbons and individual optical fibers together, angular alignment between the optical fibers may be needed.

### SUMMARY

According to a first aspect of the present disclosure, a non-circular optical fiber, comprising: a glass cladding having a cross-sectional profile, wherein the cross-sectional profile is non-circular and includes an alignment region having formation bulges, and wherein an alignment axis is defined by the formation bulges; a core arrangement including at least one glass core; and a coating coupled to and in direct contact with the glass cladding, wherein the coating defines an alignment plane along the alignment region of the glass cladding, and wherein an angle between the alignment plane and the alignment axis is less than or equal to about 15°.

According to a second aspect of the present disclosure, the non-circular optical fiber of the first aspect is presented, wherein the core arrangement defines an orientation reference line, and wherein an angle between the orientation reference line and the alignment plane is less than or equal to about 15°.

According to a third aspect of the present disclosure, the non-circular optical fiber of either one of the first aspect or the second aspect is presented, wherein the angle between the alignment plane and the alignment axis is less than or equal to about 5°.

According to a fourth aspect of the present disclosure, the non-circular optical fiber of any one of the first through third aspects is presented, wherein the alignment plane and the alignment axis are parallel.

According to a fifth aspect of the present disclosure, the non-circular optical fiber any one of the first through fourth aspect is presented, wherein the cross-sectional profile includes a D-shaped portion and the formation bulges extending from a flat side of the D-shaped portion.

According to a sixth aspect of the present disclosure, the non-circular optical fiber of the fourth aspect is presented, wherein a distance the formation bulges extend from the flat side is greater than or equal to 5 μm and less than or equal to 25 μm.

According to a seventh aspect of the present disclosure, the non-circular optical fiber of the fifth aspect is presented, wherein the formation bulges include a first formation bulge extending from a first end of the flat side and a second formation bulge extending from a second end of the flat side.

According to an eighth aspect of the present disclosure, the non-circular optical fiber of the seventh aspect is presented, wherein a distance between the first formation bulge and the second formation bulge is greater than or equal to 30 μm and less than or equal to 80 μm.

According to a ninth aspect of the present disclosure, a non-circular optical fiber comprises: a glass cladding having a cross-sectional profile, wherein the cross-sectional profile includes a D-shaped portion and formation bulges extending from a flat side of the D-shaped portion, and wherein an alignment axis extends tangentially to the formation bulges; a core arrangement including at least one glass core; and a coating coupled to and in direct contact with the glass cladding, wherein the coating defines an alignment plane, and wherein an angle between the alignment plane and the alignment axis is less than or equal to about 15°.

According to the tenth aspect of the present disclosure, the non-circular optical fiber of the ninth aspect is presented, wherein the at least one glass core includes a plurality of glass cores.

According to the eleventh aspect of the present disclosure, the non-circular optical fiber of either one of the ninth aspect or the tenth aspect is presented, wherein the formation bulges include a first formation bulge and second formation bulge, and wherein the first formation bulge extends from a first end of the flat side and the second formation bulge extends from a second end of the flat side.

According to the twelfth aspect of the present disclosure, the non-circular optical fiber of the eleventh aspect is presented, wherein the first formation bulge is spaced from a first edge of the flat side and the second formation bulge is spaced from the second edge of the flat side, and wherein a distance the first formation bulge is spaced from the first edge is greater than or equal to 5 μm and less than or equal to 10 μm, and further wherein a distance the second formation bulge from the second edge is greater than or equal to 5 μm and less than or equal to 10 μm.

According to the thirteenth aspect of the present disclosure, the non-circular optical fiber of the eleventh aspect is presented, wherein a distance between the first formation bulge and the second formation bulge is greater than or equal to 10 μm and less than or equal to 70 μm.

According to the fourteenth aspect of the present disclosure, the non-circular optical fiber of the eleventh aspect is presented, wherein a distance the first formation bulge and the second formation bulge extend from the flat side is between about 5 μm and about 25 μm.

According to the fifteenth aspect of the present disclosure, the non-circular optical fiber of any one the ninth through fourteenth aspect is presented, wherein the core arrangement defines an orientation reference line, and wherein an angle between the orientation reference line and the alignment plane is less than or equal to about 5°.

According to the sixteenth aspect of the present disclosure, the non-circular optical fiber of any one of the ninth through fifteenth aspect is present, wherein the core arrangement includes stress rods, and further wherein the stress rods and the at least one glass core align with the orientation reference line.

According to the seventeenth aspect of the present disclosure, a non-circular optical fiber, comprising: a glass cladding having a cross-sectional profile, wherein the cross-sectional profile includes a D-shaped portion and formation bulges extending from a flat side of the D-shaped portion, and wherein an alignment axis extends tangentially to the formation bulges; a core arrangement defining an orientation reference line; and a coating coupled to and in direct contact with the glass cladding, wherein the coating defines an alignment plane, and wherein an angle between the alignment plane and the orientation reference line is less than or equal to about 15°.

According to the eighteenth aspect of the present disclosure, the non-circular optical fiber of the seventeenth aspect is presented, wherein the core arrangement includes at least one of a hollow core, a plurality of glass cores, or a polarization maintaining glass core.

According to the nineteenth aspect of the present disclosure, the non-circular optical fiber of either one of the seventeenth or eighteenth aspect is presented, wherein an angle between the alignment plane and the alignment axis is less than or equal to about 5°.

According to the twentieth aspect of the present disclosure, the non-circular optical fiber of any one of the seventeenth through nineteenth aspect is presented, wherein a ratio of a first distance the formation bulges extending from the flat side to a second distance between the formation bulges is between about 1:3 and about 1:7.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiments, and together with the description serve to explain principles and operation of the various embodiments.

### BRIEF DESCRIPTION OF THE DRAWINGS

In the drawings:

FIG. 1 is a schematic perspective view of a non-circular optical fiber, according to a first implementation;

FIG. 2A is a schematic end view of a non-circular multicore optical fiber, according to a first implementation;

FIG. 2B is a schematic end view of a non-circular multicore optical fiber, according to a second implementation;

FIG. 2C is a schematic end view of a non-circular multicore optical fiber, according to a third implementation;

FIG. 3A is a schematic end view of a non-circular polarization maintaining optical fiber, according to a first implementation;

FIG. 3B is a schematic end view of a non-circular polarization maintaining optical fiber, according to a second implementation;

FIG. 4A is a schematic end view of a non-circular hollow core optical fiber, according to a first implementation;

FIG. 4B is a schematic end view of a non-circular hollow core optical fiber, according to a second implementation;

FIG. 5 is a schematic end view of a non-circular optical fiber, according to the first implementation;

FIG. 6A is a schematic end view of a non-circular optical fiber with formation bulges, according to a first implementation;

FIG. 6B is a schematic end view of a non-circular optical fiber with formation bulges, according to a second implementation;

FIG. 7 is a schematic end view of a ribbon including non-circular optical fibers;

FIG. 8 is a schematic view of a first production system for non-circular optical fibers;

FIG. 9A is a schematic cross-sectional view of rotary coating die having with a die aperture, according to a first implementation;

FIG. 9B is a schematic cross-sectional view of rotary coating die having with a die aperture, according to a second implementation;

FIG. 10A is a schematic end view of a non-circular optical fiber showing an initial coating perimeter and a cured coating perimeter, according to a first implementation;

FIG. 10B is a schematic end view of a non-circular optical fiber showing an initial coating perimeter and a cured coating perimeter, according to a second implementation;

FIG. 11A is a schematic end view of a non-circular optical fiber with formation bulges and showing an initial coating perimeter and a cured coating perimeter, according to a first implementation;

FIG. 11B is a schematic end view of a non-circular optical fiber with formation bulges and showing an initial coating perimeter and a cured coating perimeter, according to a second implementation;

FIG. 12 is a schematic view of a second production system for non-circular optical fibers;

FIG. 13 is a schematic cross-sectional view of rotary die having with a formation gap;

FIG. 14 is a schematic view of a first formation system for non-circular optical fibers;

FIG. 15 is a schematic view of a second formation system for non-circular optical fibers;

FIG. 16 is a schematic view of a third formation system for non-circular optical fibers;

FIG. 17 is a schematic view of a fourth formation system for non-circular optical fibers;

FIG. 18 is a flow chart for a method of producing a non-circular optical fiber;

FIG. 19 is a flow chart for a method of producing a non-circular optical fiber; and

FIG. 20 is a flow chart for a method of producing a non-circular optical fiber.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purpose of describing particular aspects only and is not intended to be limiting.

In this specification and in the claims which follow, reference will be made to a number of terms which shall be defined to have the following meanings:

“Include,” “includes,” or like terms means encompassing but not limited to, that is, inclusive and not exclusive.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is said to be about or about equal to a certain number, the value is within ±10% of the number. For example, a value that is about 10 refers to a value between 9 and 11, inclusive. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

In some embodiments, the term “about” references terms or endpoints in a range. For example, about 1, 2, or 3 is equivalent to about 1, about 2, or about 3, and further comprises from about 1 to 3, from about 1 to 2, and from about 2 to 3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise.

As used herein, “comprising” is an open-ended transitional phrase. A list of elements following the transitional phrase “comprising” is a non-exclusive list, such that elements in addition to those specifically recited in the list may also be present.

The term “wherein” is used as an open-ended transitional phrase, to introduce a recitation of a series of characteristics of the structure.

The terms “comprising,” and “comprises,” e.g., “A comprises B,” is intended to include as special cases the concepts of “consisting” and “consisting essentially of” as in “A consists of B” or “A consists essentially of B”.

The term “or,” as used herein, is inclusive; more specifically, the phrase “A or B” means “A, B, or both A and B.” Exclusive “or” is designated herein by terms such as “either A or B” and “one of A or B,” for example.

Reference will now be made in detail to the present preferred embodiments, examples of which are illustrated in the accompanying drawings. Whenever possible, the same reference numerals will be used throughout the drawings to refer to the same or like parts.

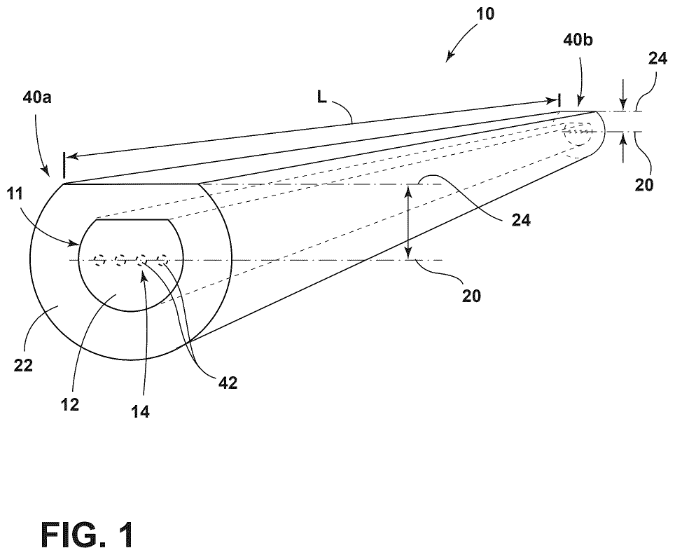

Referring to FIGS. 1-20, reference numeral 10 generally refers to a non-circular coated optical fiber including a glass fiber 11. The glass fiber 11 is an uncoated optical fiber and includes a glass cladding 12 and a core arrangement 14. The glass cladding 12 has a cross-sectional profile 16 that is non-circular and includes an alignment region 18. The core arrangement 14 defines an orientation reference line 20. A coating 22 is coupled to and in direct contact with the glass cladding 12. The coating 22 defines an alignment plane 24 along the alignment region 18 of the glass cladding 12.

Referring to FIGS. 1-4, non-circular optical fibers 10 may require angular alignment between a first non-circular optical fibers 10 coupled to a second non-circular optical fiber 10 for communication of light signals between the first and second optical fibers 10. The angular alignment may be required due to the core arrangement 14 being configured to accommodate different optical paths. The different optical paths increase bandwidth of the optical fiber 10 but also require alignment between optical fibers 10 when coupled together. Angular alignment may also be required to allow for the optical fibers 10 to be aligned with and connected to various devices in a manner that allows for easy and reliable connection between opposite terminal ends with like communication paths in connecting devices. The non-circular optical fibers 10 may be, for example, multicore optical fibers (MCF) 10a, polarization maintaining optical fibers (PMF) 10b, or hollow core optical fibers (HCF) 10c, or other optical fibers requiring angular alignment.

Referring still to FIGS. 1-4, the glass fiber 11 generally include the glass cladding 12 extending around the core arrangement 14, and in some implementations, extend within the core arrangement 14. The glass cladding 12 may be made of glass or other optical fiber material and may be doped suitable for the optical fiber 10. The core arrangement 14 may include a single core or multiple cores extending from a terminal end 40a to a distal end 40b (i.e. a length, L) of the glass fibers 11. In multicore optical fibers 10a, the core arrangement 14 includes a plurality of glass cores 42, which may include glass cores 42(a)-42(g). In polarization maintaining optical fibers 10b, the core arrangement 14 includes at least one glass core 44. In hollow core optical fibers 10c, the core arrangement 14 includes a hollow core 46.

Each of the core arrangements 14 for the multicore optical fibers 10a, the polarization maintaining optical fibers 10b, and the hollow core optical fibers 10c define the orientation reference line 20. The orientation reference line 20 generally divides the core arrangement 14 into sections. In some implementations, the orientation reference line 20 may bisect the core arrangement 14 into two substantially even sections. The even sections formed by the orientation reference line 20 may be mirrored across the orientation reference line 20. In other implementations, the orientation reference line 20 may divide the core arrangement 14 into uneven or unequal sections. Stated differently, the orientation reference line 20 may not bisect or substantially bisect the core arrangement 14. The orientation reference line 20 may extend parallel to an alignment axis 50 or a glass fiber alignment axis 50. The alignment axis 50 is generally defined by the alignment region 18 of the glass cladding 12, as discussed herein. The orientation reference line 20 may extend parallel, substantially parallel, or at an angle, A1, to the alignment axis 50. The angle A1 between the orientation reference line 20 and the alignment axis 50 may be less than or equal to about 5°, less than about or equal to 2°, or less than about or equal to 1° from parallel.

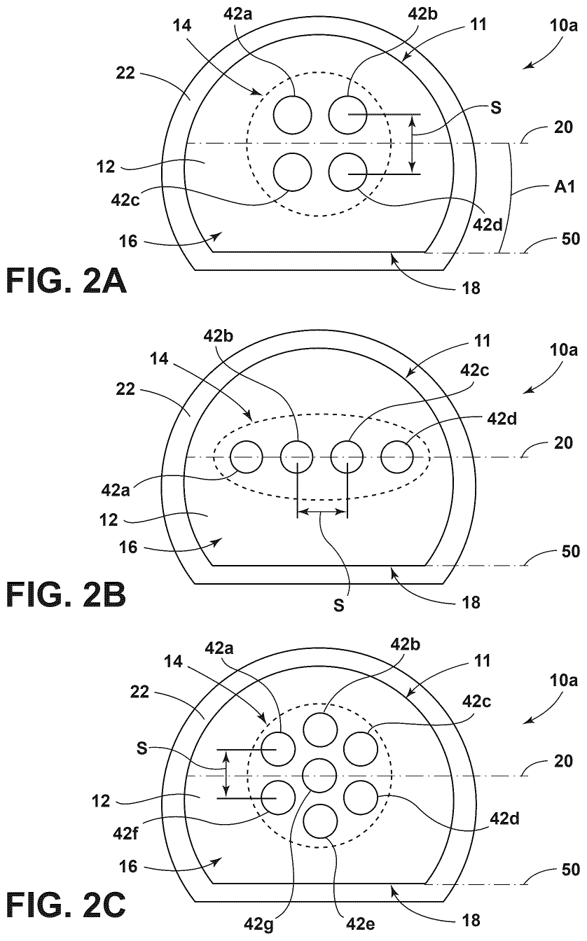

Referring to FIGS. 1-2C, the multicore optical fiber 10a is an optical fiber that includes the plurality of cores 42, each capable of communicating light signals between transceivers including transmitters and receivers which may allow for parallel processing of multiple signals. The multicore optical fiber 10a may be used for wavelength division multiplexing (WDM) or multi-level logic or for other parallel optics of spatial division multiplexing, for example.

The glass cores 42 for the multicore optical fibers 10a generally have a higher refractive index than the cladding 12. The glass fiber 11 functions as a waveguide. In many implementations, the glass cores 42 and the cladding 12 have a discernible core-cladding boundary. Alternatively, the glass cores 42 and the cladding 12 may lack a distinct boundary. One such fiber is a step-index fiber. Another such fiber is a graded-index fiber, which has cores whose refractive index varies with distance from the fiber center. A graded-index fiber is formed by diffusing the glass cores 42 and cladding 12 into one another. The cladding 12 can include one or more layers. The one or more cladding layers can include an inner cladding layer that surrounds the glass cores 42, extending within the core arrangement 14, and an outer cladding layer that surrounds the inner cladding layer. The inner cladding layer and outer cladding layer differ in refractive index. For example, the inner cladding layer may have a lower refractive index than the outer cladding layer. A depressed index layer may also be positioned between the inner cladding layer and outer cladding layer.

In a first implementation shown in FIG. 2A, the multicore optical fiber 10a has four glass cores 42a-42d arranged within the core arrangement 14 in a 2×2 array having two rows and two columns. The cladding 12 extends around each of the glass cores 42a-42d. Each of the plurality of cores 42 has a radius. Each core may have one or more concentric glass segments with different refractive indices that are designed to confine light in the core arrangement 14 to enable waveguiding of the light. In addition, the adjacent cores 42 are spaced apart from each other by a distance S (center-to-center core spacing) which is shown as a distance between the centers of adjacent cores 42. The cladding 12 extends around each of the glass cores 42a-42d. As illustrated, the orientation reference line 20 extends between the upper of the cores 42a, 42b and the lower of the cores 42c, 42d and substantially parallel to the alignment axis 50.

In a second implementation shown in FIG. 2B, the multicore optical fiber 10a has four glass cores 42a-42d arranged within the core arrangement 14 in a 4×1 array having one row and four columns. The adjacent cores 42 are evenly spaced apart from each other by a distance S. As illustrated, the orientation reference line 20 extends through each of the cores 42a-42d and substantially parallel to the alignment axis 50.

In a third implementation shown in FIG. 2C, the multicore optical fiber 10a has seven glass cores 42a-42g arranged in a hexagonal lattice. Six of the cores 42a-42f are arranged in a ring-shaped pattern within the core arrangement 14 and the seventh core 42g located in the center of the ring shape pattern of the six cores 42a-42f. The cores 42a-42f within the ring shape are evenly spaced by spacing S. The cladding 12 extends around each of the glass cores 42a-42g. As illustrated, the orientation reference line 20 extends through the seventh core 42g, divides the ring shape pattern of cores 42a-42f into upper cores 42a-42c and lower cores 42d-42f, and extends substantially parallel to the alignment axis 50.

The multicore optical fiber 10a is not limited to the implementations discussed above. The multicore optical fiber 10a may include any number of glass cores 42 within the core arrangement 14. The cores 42 may be evenly spaced from one another but it is contemplated that the spacing may be varied.

Two multicore optical fiber 10a having the same core structures may be coupled together to extend the length of the optical pathways and couple various devices together. The distal end 40b of a first multicore optical fiber 10a may be coupled to the terminal end 40a of a second multicore optical fiber 10a to form multiple optical pathways. Angular alignment of the first multicore optical fiber 10a and the second multicore optical fiber 10a is generally needed to maintain to maintain consistent optical paths from the terminal end 40a of the first optical fiber 10a to the distal end 40b of the second optical fiber 10a. For example, referring to the first implementation shown in FIG. 2A, by aligning the four cores 42a-42d for the first multicore optical fiber 10a with the four cores 42a-42d for the second multicore optical fiber 10a, respectively, consistent optical pathways are formed between the multicore optical fibers 10a. This, for example, ensures that the optical pathway formed along the first core 42a in each of the multicore optical fibers 10a are optically coupled and is able to be consistently and reliably connected to various devices at each end.

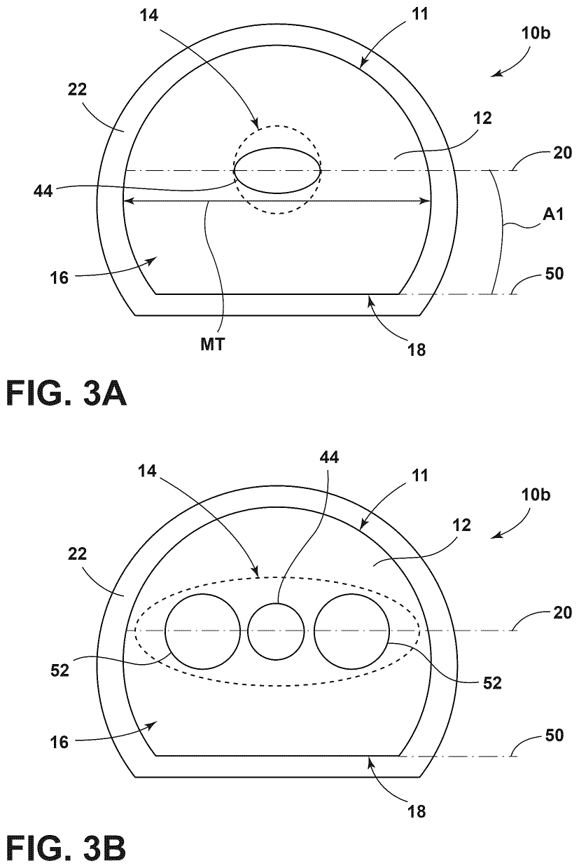

Referring to FIGS. 3A and 3B, the polarization maintaining optical fibers 10b generally includes the at least one glass core 44 extending from the terminal end 40a to the distal end 40b of the glass fiber 11 within the core arrangement 14. The polarization maintaining optical fiber 10b may be a single-mode optical fiber configured to maintain the linear polarization of light propagating through the glass core 44. In various implementations, the glass core 44 has an elliptical outer diameter to maintain the polarization injected into the optical fiber 10b. In other implementations, the glass core 44 may have a circular or substantially circular outer diameter to maintain the polarization of the light injected into the optical fiber 10b. As shown in FIG. 3B, the core arrangement 14 may also include stress rods 52 extending along the length of the glass fiber 11. The stress rods 52 are generally configured to assist in maintaining the polarization of light within the glass core 44.

The glass fiber 11 of the polarization maintaining optical fibers 10b includes the core arrangement 14 and the cladding 12. The glass core 44 generally has a higher refractive index than the cladding 12. The glass fiber 11 functions as a waveguide. In many implementations, the glass core 44 and the cladding 12 have a discernible core-cladding boundary. The cladding 12 may extend within the core arrangement 14 and surround the glass core 44. The cladding 12 may also extend around the stress rods 52, as shown in FIG. 3B. The cladding 12 can include one or more layers. The one or more cladding layers can include an inner cladding layer that surrounds the glass cores 44 and an outer cladding layer that surrounds the inner cladding layer. The inner cladding layer and outer cladding layer differ in refractive index. For example, the inner cladding layer may have a lower refractive index than the outer cladding layer. A depressed index layer may also be positioned between the inner cladding layer and outer cladding layer.

In a first exemplary implementation shown in FIG. 3A, the core arrangement 14 of the polarization maintaining optical fiber 10b includes the glass core 44 having an elliptical outer perimeter. The orientation reference line 20 extends between narrow ends of the elliptical outer perimeter and substantially parallel with alignment axis 50. In a second exemplary implementation shown in FIG. 3B, the core arrangement 14 of the polarization maintaining optical fiber 10b includes the glass core 44 having the circular outer perimeter and two stress rods 52. The orientation reference line 20 bisects the glass core 44 and the two stress rods 52 and extends substantially parallel to the alignment axis 50.

Two polarizations maintaining optical fibers 10b may be coupled together extend the length optical pathways and couple various devices together. The distal end 40b of a first polarization maintaining optical fibers 10b may be coupled to the terminal end 40a of a second polarization maintaining optical fibers 10b to form multiple optical pathways. Angular alignment between the first polarization maintaining optical fibers 10b and the second polarization maintaining optical fibers 10b is generally needed to maintain polarization of the light propagating between the first and second optical fibers 10b. By maintaining the polarization between the first and second optical fibers 10b consistently, optical pathways are maintained along the length of the coupled optical fibers 10b, which allows for easy and reliable connection between the terminal end 40a of the first optical fiber 10b and the distal end 40b of the second optical fiber 10b to various devices.

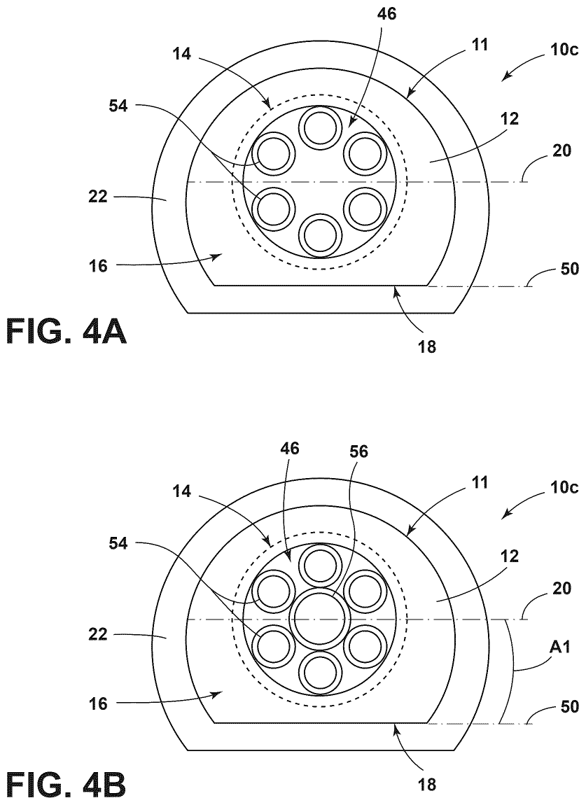

Referring to FIGS. 4A and 4B, the hollow core optical fiber 10c generally includes the hollow core 46 extending the length of the optical fiber 10c and is configured to propagate light along the length of the optical fiber 10c. There are three types of hollow core fibers 10c. The first type is Bragg hollow core fibers 10c, in which the cladding 12 is a Bragg structure of concentric periodic dielectric multilayers that confine light in a hollow (air) region 46. The second type is photonic bandgap hollow core fibers 10c that use a two-dimensional photonic crystal structure with periodically arranged air holes that confine light in the hollow core 46. The third type is anti-resonant hollow core fibers 10c, in which the glass fiber 11 comprises one or more layers of thin glass tubes to prevent light from leaking out of the air core 46. The hollow core fiber 10c illustrated in FIGS. 4A and 4B is an exemplary example of an anti-resonant hollow core optical fiber 10c.

The glass fiber 11 of the hollow core optical fiber 10c includes the cladding 12 defining the hollow core 46. The hollow core 46 includes a plurality of structural tubes 54, which may be disposed radially around the hollow core 46. In some implementations, as illustrated in FIG. 4A, the structural tubes 54 may be directly coupled to the cladding 12 and extend the length of the hollow core optical fiber 10c. In other implementations, as illustrated in FIG. 4B, a central support tube 56 may be disposed within the structural tubes 54 to support them within the hollow core 46. The structural tubes 54 may not be coupled to the cladding 12 while directly contacting the cladding 12 when supported by the central support tube 56. A plurality of the central support tube 56 may be spaced along the length of the hollow core optical fiber 10c to support portions of the structural tubes 54 along the length of the optical fiber 10c. It is contemplated that the central support tube 56 may extend the length of the hollow core optical fiber 10c.

Two hollow core optical fiber 10c may be coupled together extend the length optical pathways and couple various devices together. The distal end 40b of a first hollow core optical fiber 10c may be coupled to the terminal end 40a of a second hollow core optical fiber 10c to form multiple optical pathways. Angular alignment between the first hollow core optical fiber 10c and the second hollow core optical fiber 10c may be needed to align the structural tubes 54. The distal end 40b of the first optical fiber 10c is generally coupled to the terminal end 40a of the second optical fiber 10c. Alignment of the structural tubes 54 may assist in propagating light between the terminal end 40a of the first optical fibers 10c and the distal end 40b of the second optical fiber 10c.

Referring to FIGS. 2-6B, the cladding 12 is generally in direct contact with and extends around the glass cores 42, 44 or forms an outside wall of the core 46. The cross-sectional profile 16 of the cladding 12 is generally non-circular and includes the alignment region 18. In some implementations, the glass cladding 12 may be rotationally asymmetric. The glass cladding 12 may have a maximum thickness, MT. In some embodiments, the maximum thickness, MT, may be greater than or equal to 40 μm, greater than or equal to 60 μm, greater than or equal to 80 μm, greater than or equal to 100 μm, greater than or equal to 120 μm, greater than or equal to 140 μm, greater than or equal to 160 μm, or greater. In some embodiments, the maximum thickness, MT, may be less than or equal to 190 μm, less than or equal to 170 μm, less than or equal to 150 μm, less than or equal to 130 μm, less than or equal to 110 μm, less than or equal to 90 μm, less than or equal to 70 μm, less than or equal to 50 μm, or less. In some embodiments, the maximum thickness, MT, may be about 150 μm, about 145 μm, about 140 μm, about 135 μm, about 130 μm, about 125 μm, about 120 μm, about 115 μm, about 110 μm, about 105 μm, about 100 μm, about 95 μm, about 90 μm, about 85 μm, about 80 μm, about 75 μm, about 70 μm, about 65 μm, about 60 μm, about 55 μm, about 50 μm, about 45 μm, or within any range bound by any two of those values. The alignment region 18 defines the glass fiber alignment axis 50 extending the lengths, L, of the glass fiber 11. The glass fiber alignment axis 50 defines a fixed angular orientation along the length, L, of the glass fiber 11, which may assist with angular alignment of two glass fibers 11. The fixed angular orientation of each of the glass fibers 11 allows for the two glass fibers 11 to be substantially angularly aligned without using additional tools. The substantial angular alignment between the two glass fibers 11 allows for more efficient coupling of the two glass fibers 11.

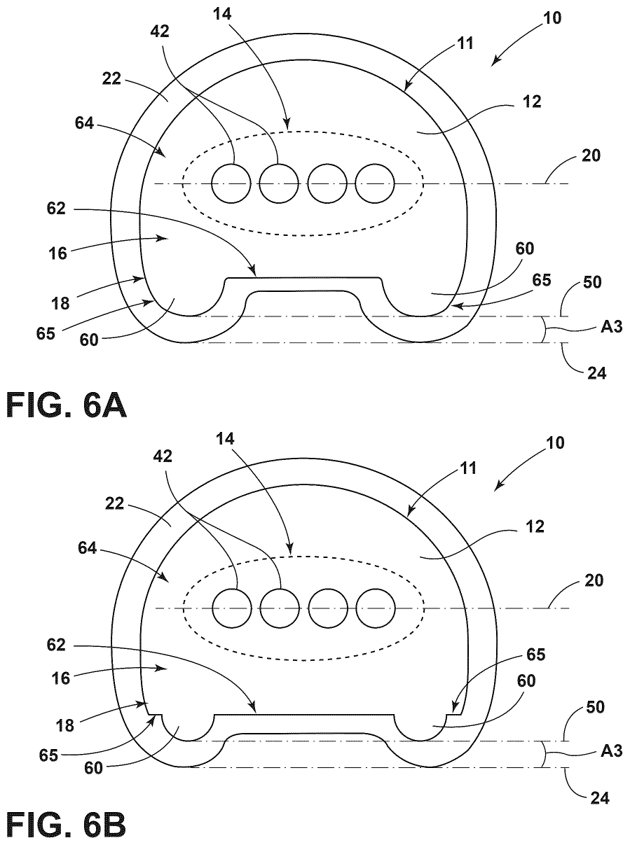

The alignment region 18 may be flat or include other features to define the alignment axis 50. In the implementations illustrated in FIGS. 2-5, the cladding 12 has an alignment region 18 that is flat defining the alignment axis 50. The cross-sectional profiles 16 of the glass fibers 11 are generally D-shaped (i.e. a D-shaped profile) forming the flat alignment region 18. In the implementations illustrated in FIGS. 6A and 6B, the alignment region 18 includes two formation bulges 60. The formation bulges 60 extend from a flat side 62 of a D-shaped portion 64 of the cross-sectional profile 16. The formation bulges 60 may extend from edges 65 of the flat side 62. In some implementations, the formation bulges 60 may be spaced from the edges 65 of the flat side 62. The alignment axis 50 extends tangentially between the two formation bulges 60. While the alignment region 18 is depicted as having two formation bulges 60, it is contemplated that the alignment region 18 may include more than two formation bulges 60 to define the alignment axis 50. The formation bulges 60 may be configured to assist in forming the alignment plane 24 defined by the coating 22, as discussed further herein.

The non-circular optical fiber 10 includes the coating 22 surrounding the cladding 12. The coating 22 generally is in direct contact with the cladding 12 and forms a protective layer. The coating 22 may define the alignment plane 24 to assist in the angular alignment of the non-circular optical fiber 10. The alignment plane 24 extends the length L of the optical fiber 10 and assists in the angular alignment along the full-length, L, of the optical fiber 10. The alignment plane 24 provides for an initial angular alignment of the optical fiber 10.

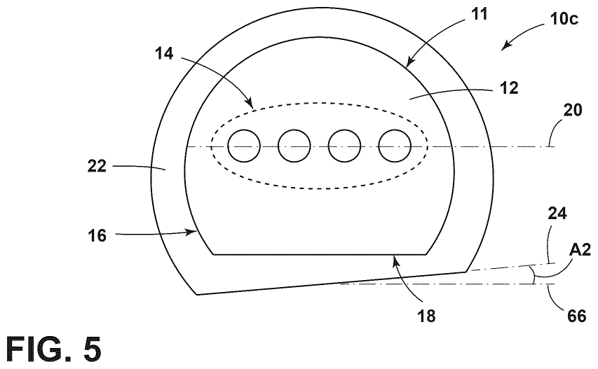

The alignment plane 24 generally extends parallel, substantially parallel, or at an angle, A2, to the orientation reference line 20. As illustrated in FIG. 5, a line 66 that extends parallel to the orientation reference line 20 is illustrated to assist in showing the angle A2 between the orientation reference line 20 and the alignment plane 24. The angle A2 between the orientation reference line 20 and the alignment plane 24 may be less than or equal to about 15°, less than or equal to about 10°, or less than or equal to about 5° from parallel. The angle A2 from parallel between the orientation reference line 20 and the alignment plane 24 may be about 15°, about 14°, about 13°, about 12°, about 11°, about 10°, about 9°, about 8°, about 7°, about 6°, about 5°, about 4°, about 3°, about 2°, about 1°, about 0.5°, or within any range bound by any two of those values (e.g., from about 1° to about 15°, from about 5° to about 10°, from about 0.5° to about 5°, etc.).

The alignment plane 24 generally extends parallel, substantially parallel, or at an angle, A3, to the alignment axis 50. The angle A3 between the alignment axis 50 and the alignment plane 24 may be less than or equal to about 15°, less than or equal to about 10°, or less than or equal to about 5° from parallel. The angle A3 from parallel between the alignment axis 50 and the alignment plane 24 may be about 15°, about 14°, about 13°, about 12°, about 11°, about 10°, about 9°, about 8°, about 7°, about 6°, about 5°, about 4°, about 3°, about 2°, about 1°, about 0.5°, or within any range bound by any two of those values (e.g., from about 1° to about 15°, from about 5° to about 10°, from about 0.5° to about 5°, etc.). The parallel relationship or the angle, A3, between the alignment plane 24 and the alignment axis 50 may assist in the angular alignment between the two non-circular optical fibers 10 and increase the efficiency of coupling the glass fibers 11 together.

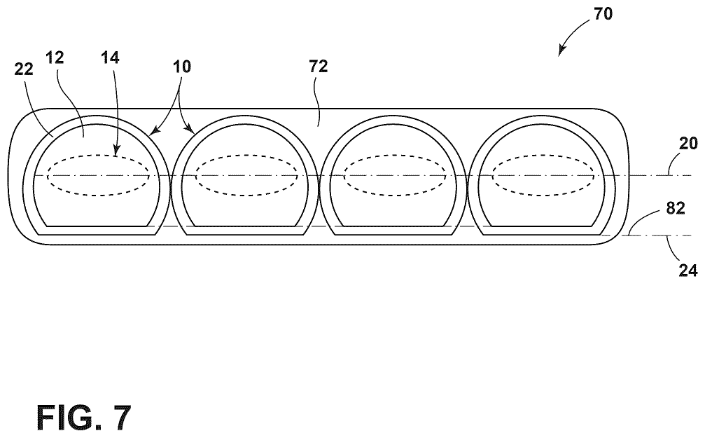

Referring still to FIGS. 2-6B, and now also FIG. 7, an oriented optical fiber ribbon 70 may be formed using a plurality of the non-circular optical fibers 10 and aligning the alignment planes 24 along a single plane 82. The optical fibers 10 may be coupled together using a second coating 72 extending around the coatings 22 of the optical fibers 10, using a sleeve or other coupling method. In some implementations, the orientation reference lines 20 of each of the optical fibers may be substantially parallel to each of the other orientation reference lines of the ribbon 70 due to the initial orientation of each of the optical fibers 10. In other implementation, the orientation reference lines 20 of each of the optical fibers 10 in the ribbon 70 may be at varied angles to each other. Regardless, if two oriented optical fiber ribbons 70 have the same construction (e.g., same number, type, and/or orientation of optical fibers 10), the initial angular alignment of each of the optical fibers 10 allows for efficient angular alignment between corresponding optical fibers 10 of each ribbon 70. Additionally, having a known angular alignment of each of the optical fibers 10 in the oriented optical fiber ribbon 70 increase the efficiency of attaching a connector or other device to the ribbon 70.

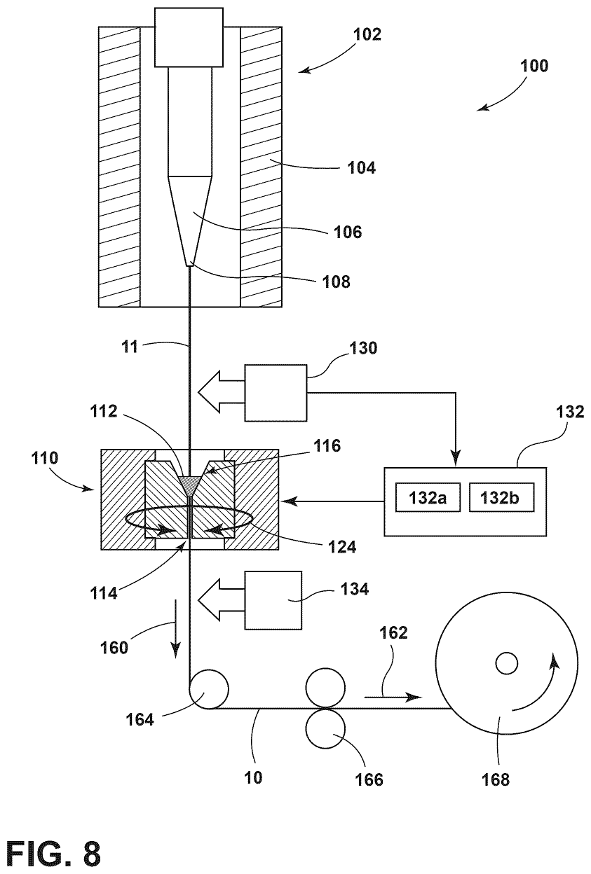

Referring to FIGS. 8-17, the alignment plane 24 of the coating 22 for the non-circular optical fiber 10 may be formed during or after a fiber draw process. When the alignment plane 24 is formed during the fiber draw process, the non-circular optical fiber 10 is generally fully formed and complete. When the alignment plane 24 is formed after the fiber draw process, the non-circular optical fiber 10 is partially formed during the draw process and completed during a secondary coating formation process.

Referring to FIGS. 8, a first implementation of a production system 100 for producing the non-circular optical fiber 10 is illustrated. The production system 100 may include a draw furnace 102 that includes a heating element 104 and a preform 106 disposed substantially vertical within the heating element 104. In various examples, the preform 106 may include glass materials and/or silica-based glass materials. Additionally or alternatively, the preform 106 may be doped or otherwise processed for manufacture into the optical fiber 10.

The optical fiber 10 may be drawn from the heated preform 106 in the form of the glass fiber 11 (i.e., the optical fiber 10 without the coating 22). The heating element 104 supplies heat to at least a portion of the preform 106. In various examples, the optical fiber 10 may be pulled from a root portion 108 of the preform 106 by a tractor or other device configured to pull a consistent optical fiber 10.

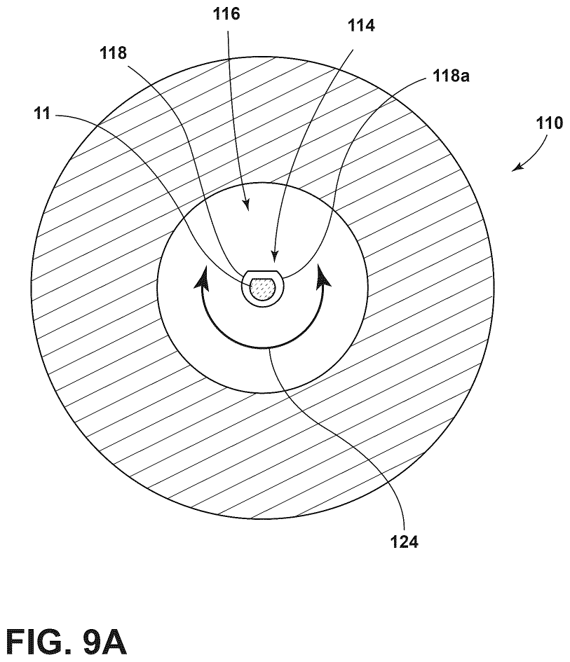

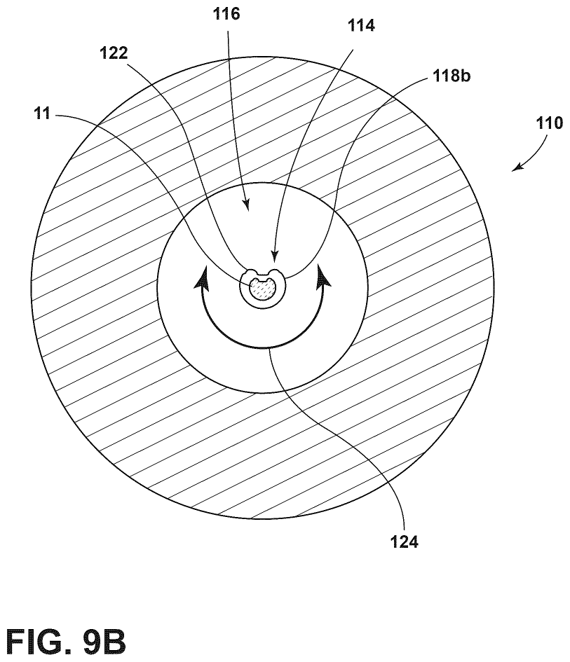

Referring still to FIG. 8, and now also FIGS. 9A and 9B, the production system 100 may further include a rotary coating die 110 configured to coat the glass fiber 11. The rotary coating die 110 is configured to coat the glass fiber 11 with an uncured coating 112 to form the optical fiber 10. The rotary coating die 110 includes a die aperture 114 configured to apply the uncured coating 112 at a desired or initial thickness, T1, to the glass fiber 11, which may be greater than the final thickness of the cured coating in some embodiments. The rotary coating die 110 includes a coating funnel structure 116 configured to pool the uncured coating 112 above the die aperture 114. The glass fiber 11 is pulled through the pooled uncured coating 112.

The die aperture 114 has a perimeter 118 to form the uncured coating layer 112 having the initial thickness T1 and an initial coating perimeter 120. The perimeter 118 of the die aperture 114 has a substantially similar shaped perimeter to the glass fiber 11 being coated (i.e., the cross-sectional profile 16 of the cladding 12). In one example shown in FIG. 9A, when the glass fiber 11 has the D-shaped profile as illustrated in FIGS. 1-5, the die aperture 114 has a D-shaped perimeter 118a having the flat portion corresponding to the alignment region 18 of the cladding 12. In another example shown in FIG. 9B, when the glass fiber 11 has the formation bulges 60 extend from the flat side 62 of the D-shaped portion 64 illustrated in FIGS. 6B and 6B, the die aperture 114 has a D-shaped perimeter 118b with bulges 122 corresponding to the alignment region 18 of the cladding 12. The die aperture 114 is not limited to these perimeters 118a, 118b and may be any perimeter having a similar shape as the cross-sectional profile 16 of the cladding 12. It is contemplated that the perimeter 118 of the die aperture 114 may have a different shape than the cross-sectional profile 16 of the cladding 12.

During the draw process, the glass fiber 11 may not be rotationally aligned with the die aperture 114. To correct for misalignment, the rotary coating die 110 is operably coupled to a motor or actuator to rotate, as shown by arrow 124, the die aperture 114 around an axis defined by the glass fiber 11 traveling therethrough. A fiber rotation measurement sensor 130, which may be an optical sensor, an infrared light sensor or other sensor, is configured to sense the rotational location of the alignment region 18 of the glass fiber 11. The fiber rotation measurement sensor 130 is communicatively coupled to a controller 132. The controller 132 is communicatively coupled to the rotary coating die 110. Using the input of the fiber rotation measurement sensor 130 and rotational position of the die aperture 114, the controller 132 activates the actuator to rotate the die aperture 114 to align the glass fiber 11 with the aperture 114 as it is drawn therethrough. The rotational position of the die aperture 114 may be determined by positional variation based on inputs by the actuator and a known zero position, a position sensor, or other method configured to determine the rotational position of the die aperture 114.

The controller 132 may include a microprocessor or a processor 132a and a memory 132b. The memory 132b may store instructions executable by the processor 132a. It is contemplated that any digital and/or analog processing circuitry and memory storage medium may be employed. The controller 132 may be coupled to display or other human machine interface (HMI) for a user to view position data or other operational information of the rotary coating die 110 or the production system 100. It is contemplated that a heated preform may be rotated to align the glass fiber 11 with a die aperture of a coating die instead of the rotary coating die 110 being used to align the die aperture 114. A similar control system as the rotary coating die 110 may be used to control the rotation of the heated preform.

Referring to FIGS. 8 and 10A-11B, once the glass fiber 11 passes through the rotary coating die 110, the glass fiber 11 with the uncured coating 112 passes through a curing device 134. In some implementations, the curing device 134 is an ultraviolet light and the uncured coating 112 is UV light reactive (i.e., including a photo-initiator). In other implementations, the curing device 134 may be a light and the uncured coating 112 is light reactive.

As the glass fiber 11 with the uncured coating 112 travels to and past the curing device 134 and cures, the uncured coating 112 deforms from the initial coating perimeter 120 to a cured coating perimeter 140 of the coating 22. The uncured coating 112 deforms due to surface tension of the uncured coating 112. The amount the uncured coating 112 deforms due to surface tension is affected by the viscosity of the uncured coating 112, the temperature of the coating 112, and time and distance between the curing device 134 and the die aperture 114. Additionally, the cross-sectional profile 16 of the glass fiber 11 may affect how the uncured coating perimeter 120 deforms due to the surface tension and the resulting cured coating perimeter 140. Each of these can be controlled to reduce the amount of deformation.

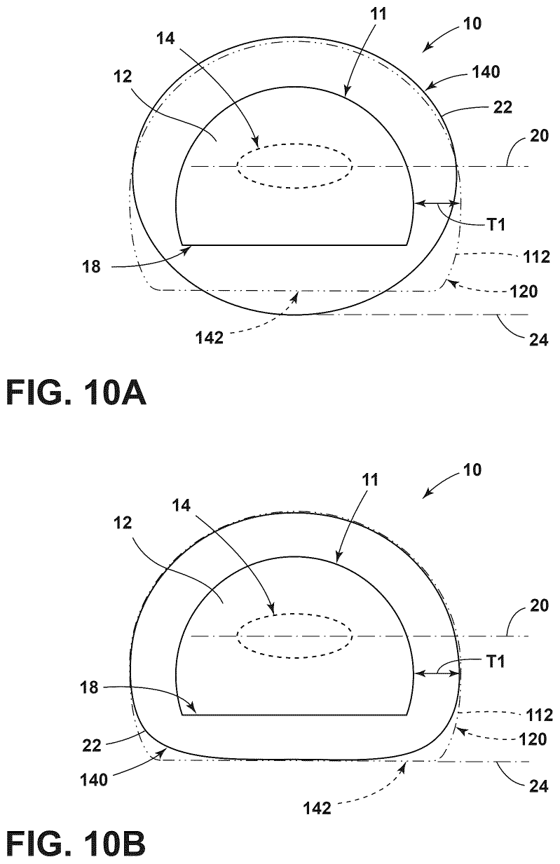

Referring to FIGS. 10A and 10B, the cross-sectional profile 16 of the glass fiber 11 is D-shaped having the flat alignment region 18. During the coating process using the production system 100, the flat alignment region 18 is aligned with the D-shaped perimeter 118a of the die aperture 114. The glass fiber 11 with the uncured coating 112 exits the die aperture 114 having the initial coating perimeter 120 with the initial thickness T1. The initial coating perimeter 120 includes a flat region 142. However, the flat region 142 rounds and deforms as it cures to the coating 22 with the cured coating perimeter 140.

The viscosity of the uncured coating 112 affects the extent of the rounding of the flat region 142 during the curing process. As illustrated in FIG. 10A, the glass fiber 11 was coated with a low viscosity coating, which causes the uncured coating 112 to deform more before and during curing. The low viscosity coating allows for the uncured coating 112 to more freely flow and flow for longer distances around the fiber. As a result, the uncured coating 112 deforms more and may cause the alignment plane 24 of the cured coating 22 to be reduced or eliminated. As illustrated in FIG. 10B, the glass fiber 11 was coated with a higher viscosity coating, which reduces the deformation of the uncured coating 112 while curing. The higher viscosity coating may allow for the alignment plane 24 to be maintained or partially maintained. However, even when the alignment plane 24 of the coating 22 is maintained, the effectiveness may be reduced due to the partial rounding.

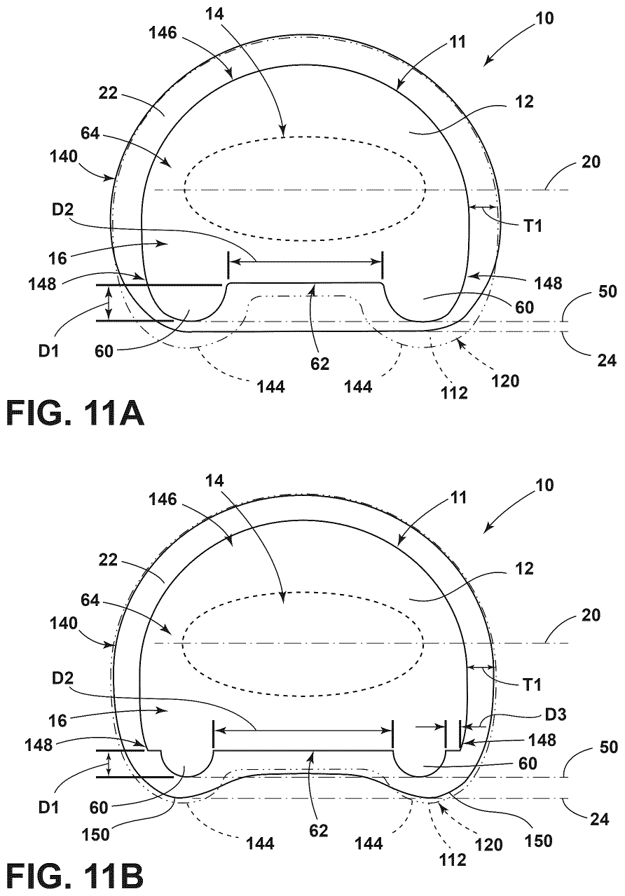

Referring to FIGS. 11A and 11B, the flow and deformation of the uncured coating 112 may be controlled and guided by including the formation bulges 60 on the glass fiber 11. During the coating process using the production system 100, the formation bulges 60 extending from the flat side 62 of the D-shaped portion 64 of the cross-sectional profile 16 align with the D-shaped perimeter 118b with bulges 122 of the die aperture 114. The glass fiber 11 with the uncured coating 112 exits the die aperture 114 having the initial coating perimeter 120 with the initial thickness T1. The initial coating perimeter 120 includes bulges 144. As the uncured coating 112 cures, the bulges 144 flatten with the uncured coating 112 flowing between the bulges 144 resulting in the coating 22 forming an alignment plane 24. The formation bulges 60 enable the flow of the uncured coating 112 to form the alignment plane 24 because the uncured coating 112 is directed between the formation bulges 60. The formation bulges 60 may naturally promote the flat alignment plane 24, unlike the glass fiber 11 having the D-shaped cross-sectional profile 16, shown in FIG. 10A and 10B, which may cause the uncured coating 112 to round.

The spacing and size of the formation bulges 60 effects deformation of the uncured coating 112 and the formation of the alignment plane 24. To control the formation of the alignment plan 24, the formation size and spacing of the formation bulges 60 can be adjusted. A distance, D1, the formation bulges 60 extend from the D-shaped portion 64 of the cross-sectional profile 16 can be adjusted. The distance D1 the formation bulges 60 extend may assist in promoting the uncured coating 112 to flow to the gap between the formation bulges 60. The distance D1 the formation bulges 60 extend may be greater than or equal to 5 μm and less than or equal to 25 μm—including all sub-ranges or values therebetween. For example, the distance D1 the formation bulges 60 extend may be greater than or equal to 5 μm and less than or equal to 25 μm, greater than or equal to 5 μm and less than or equal to 20 μm, greater than or equal to 5 μm less than or equal to 15 μm, greater than or equal to 5 μm and less than or equal to 10 μm, greater than or equal to 10 μm and less than or equal to 25 μm, greater than or equal to 10 μm and less than or equal to 20 μm, greater than or equal to 10 μm less than or equal to 15 μm, greater than or equal to 15 μm and less than or equal to 25 μm, greater than or equal to 15 μm and less than or equal to 20 μm, or greater than or equal to 20 μm and less than or equal to 25 μm. In some implementations, the distance D1 the formation bulges 60 extend may be greater than or equal to 5 μm, greater than or equal to 10 μm, greater than or equal to 15 μm, greater than or equal to 20 μm, greater than or equal to 25 μm, or greater. In some implementations, the distance D1 the formation bulges 60 extend may be less than or equal to 25 μm, less than or equal to 20 μm, less than or equal to 15 μm, less than or equal to 10 μm, less than or equal to 5 μm, or less.

A distance, D2, between the formation bulges 60 may also be adjusted to assist in promoting or reducing the flow of the uncured coating 112 to the gap between the formation bulges 60 to form the alignment plane 24. The distance D2 between the formation bulges 60 may be greater than or equal to 30 μm and less than or equal to 80 μm—including all sub-ranges or values therebetween. For example, in some implementations, the distance D2 between the formation bulges 60 may be greater than or equal to 30 μm and less than or equal to 80 μm, greater than or equal to 30 μm and less than or equal to 70 μm, greater than or equal to 30 μm and less than or equal to 60 μm, greater than or equal to 30 μm and less than or equal to 50 μm, greater than or equal to 30 μm and less than or equal to 40 μm, greater than or equal to 40 μm and less than or equal to 80 μm, greater than or equal to 40 μm and less than or equal to 70 μm, greater than or equal to 40 μm and less than or equal to 60 μm, greater than or equal to 40 μm and less than or equal to 50 μm, greater than or equal to 50 μm and less than or equal to 80 μm, greater than or equal to 50 μm and less than or equal to 70 μm, greater than or equal to 50 μm and less than or equal to 60 μm, greater than or equal to 60 μm and less than or equal to 80 μm, greater than or equal to 60 μm and less than or equal to 70 μm, or greater than or equal to 70 μm and less than or equal to 80 μm. In some implementations, the distance D2 between the formation bulges 60 may be greater than or equal to 30 μm, greater than or equal to 40 μm, greater than or equal to 50 μm, greater than or equal to 60 μm, greater than or equal to 70 μm, greater than or equal to 80 μm, or greater. In some implementations, the distance D2 between the formation bulges 60 may be less than or equal to 80 μm, less than or equal to 70 μm, less than or equal to 60 μm, less than or equal to 50 μm, less than or equal to 40 μm, less than or equal to 30 μm, or less.

As illustrated in FIG. 11A, the formation bulges 60 are continuous and extend from a curved portion 146 of the D-shaped portion 64 of the cross-sectional profile 16 (i.e., the formation bulges 60 are not spaced from edges 148 of the flat side 62 of the D-shaped portion 64). The uncured coating 112 flows between the formation bulges 60 during the curing process, forming a flat alignment plane 24. In some implementations where additional layers or protective coatings are present, such as in a ribbon 70, the glass fiber 11 with the relatively thin coating 22 near the formation bulges 60 may be further protected from damage. Additionally, the flat alignment plane 24 formed by the formation bulges 60 continuous with the curved portion 146 of the cross-sectional profile 16 may be advantageous for more efficient alignment of the core arrangements 14 in optical fibers 10 being coupled together.

In some implementations of the optical fiber 10, to provide additional protection for the glass fiber 11 near the formation bulges 60, a thicker coating may be implemented near the formation bulges 60. The location of the formation bulges 60 of the flat side 62 of the cross-sectional profile 16 may be adjusted to form a more consistent thickness of the coating 22. As illustrated in FIG. 11B, the formation bulges 60 are spaced from the edges 148 of the flat side 62. Due to the spacing from the edges 148, the uncured coating 112 flows toward the space between the formation bulges 60 and the edges 148 during the curing process. As a result, the cured coating perimeter 140 forms the alignment plane 24 between two apexes of bulges 150 in the coating 22. As such, the coating 22 maintains a more consistent thickness around the glass fiber 11. In these embodiments, the distance D2 between the formation bulges 60 may be greater than or equal to 10 μm and less than or equal to 70 μm—including all sub-ranges or values therebetween. For example, in some implementations, the distance D2 between the formation bulges 60 may be greater than or equal to 10 μm and less than or equal to 70 μm, greater than or equal to 10 μm and less than or equal to 55 μm, greater than or equal to 10 μm and less than or equal to 40 μm, greater than or equal to 10 μm and less than or equal to 25 μm, greater than or equal to 25 μm and less than or equal to 70 μm, greater than or equal to 25 μm and less than or equal to 55 μm, greater than or equal to 25 μm and less than or equal to 40 μm, greater than or equal to 40 μm and less than or equal to 70 μm, greater than or equal to 40 μm and less than or equal to 55 μm, or greater than or equal to 55 μm and less than or equal to 70 μm. In some implementations, the distance D2 between the formation bulges 60 may be greater than or equal to 10 μm, greater than or equal to 20 μm, greater than or equal to 30 μm, greater than or equal to 40 μm, greater than or equal to 50 μm, greater than or equal to 60 μm, greater than or equal to 70 μm, or greater. In some implementations, the distance D2 between the formation bulges 60 may be less than or equal to 70 μm, less than or equal to 60 μm, less than or equal to 50 μm, less than or equal to 40 μm, less than or equal to 30 μm, less than or equal to 20 μm, less than or equal to 10 μm, or less.

The formation bulges 60 may be spaced a distance, D3, from the edges 148 of the flat side 62. The distance D3 the formation bulges 60 is spaced from the edges 148 may be adjusted to assist in promoting or reducing the flow of the uncured coating 112 and controlling the thickness of the cured coating at the apexes of the bulges 150. The distance D3 of the formation bulges 60 from the edges 148 may be between about 5 μm and about 10 μm—including all sub-ranges or values therebetween. For example, in some embodiments, the distance D3 of the formation bulges 60 from the edges 148 may be greater than or equal to 5 μm and less than or equal to 10 μm, greater than or equal to 5 μm and less than or equal to 9 μm, greater than or equal to 5 μm and less than or equal to 8 μm, greater than or equal to 5 μm and less than or equal to 7 μm, greater than or equal to 5 μm and less than or equal to 6 μm, greater than or equal to 6 μm and less than or equal to 10 μm, greater than or equal to 6 μm and less than or equal to 9 μm, greater than or equal to 6 μm and less than or equal to 8 μm, greater than or equal to 6 μm and less than or equal to 7 μm, greater than or equal to 7 μm and less than or equal to 10 μm, greater than or equal to 7 μm and less than or equal to 9 μm, greater than or equal to 7 μm and less than or equal to 8 μm, greater than or equal to 8 μm and less than or equal to 10 μm, greater than or equal to 8 μm and less than or equal to 9 μm, or greater than or equal to 9 μm and less than or equal to 10 μm. In some embodiments, the distance D3 of the formation bulges 60 from the edges 148 may be less than or equal to 10 μm, less than or equal to 9 μm, less than or equal to 8 μm, less than or equal to 7 μm, less than or equal to 6 μm, less than or equal to 5 μm, or less. In some embodiments, the distance D3 of the formation bulges 60 from the edges 148 may be greater than or equal to 5 μm, greater than or equal to 6 μm, greater than or equal to 7 μm, greater than or equal to 8 μm, greater than or equal to 9 μm, greater than or equal to 10 μm, or greater.

In the various embodiments described herein, each of the distance D1 the formation bulges 60 extending from the flat side of the D-shaped portion 64 of the cross-sectional profile 16, the distance D2 between the formation bulges 60, and/or the distance D3 of the formation bulges 60 from the edges 148, if present, may be adjusted to control the thickness of the cured coating perimeter 140 and the flatness of the alignment plane 24.

In some implementations, a ratio of the distance D1 the formation bulges 60 extending from the flat side of the D-shaped portion 64 to the distance D2 between the formation bulges 60 may be between about 1:3 and about 1:7—including all sub-ranges or values therebetween. For example, in some implementations, a ratio of the distance D1 the formation bulges 60 extending from the flat side of the D-shaped portion 64 to the distance D2 between the formation bulges 60 may be between about 1:3 and about 1:7, between about 1:4 and about 1:7, between about 1:5 and about 1:7, between about 1:6 and about 1:7, between about 1:3 and about 1:6, between about 1:4 and about 1:6, between about 1:5 and about 1:6, between about 1:3 and about 1:5, between about 1:4 and about 1:5, or between about 1:3 and about 1:4.

In some implementations, a ratio of the distance D3 the formation bulges 60 spaced from the edges 148, if present, to the distance D1 the formation bulges 60 extending from the flat side of the D-shaped portion 64 may be less than or equal to 1:2, less than or equal to 1:3, less than or equal to 1:4, less than or equal to 1:5, or less to promote the formation of a more consistent thickness of the coating 22 around the formation bulges 60.

The flat alignment plane 24 formed by the formation bulges 60 increases the efficiency of aligning of the optical fibers 10 for use in the oriented optical fiber ribbon 70. Additionally, the flat alignment plane 24 increases the efficiency of angularly aligning two glass fibers 11 to be coupled together. Further, the flat alignment plane 24 increases the efficiency of attaching connectors to couple to optical fibers 10. The formation bulges 60 may also provide for a wider range of cured coating perimeters 140 that form the flat alignment plane 24, which may extend between apexes of cured coating perimeters 140. The wider range of cured coating perimeters 140 that form the flat alignment plane 24 may increase the formation window, making it more efficient to create the alignment plane 24 than using the glass fiber 11 having the D-shaped cross-sectional profile 16, shown in FIG. 10A and 10B. Additionally, the formation bulges 60 may allow for the formation of the alignment plane 24 over a wide range of initial thickness T1 of the uncured coating 112.

Referring again to FIGS. 9A-11B, the viscosity of the uncured coating 112 may also be varied around the perimeter 118 of the die aperture 114. The viscosity may be varied by, for example, exposing the fiber to IR, UV, or microwave radiation from one side, or by designing the coating die with separate feed cavities that can deliver different coating materials to different sides of the fiber. By controlling the viscosity at specific locations around die aperture 114, the deformation of the uncured coating 112 may be controlled allowing for more or less deformation at specific points around the perimeter 118. For example, in implementation where the glass fiber 11 has the D-shape cross-sectional profile 16, the viscosity of the uncured coating 112 may be reduced along the flat portion of the D-shaped perimeter 118a of the die aperture 114. Consequently, the uncured coating 112 deforms less along the flat portion of the D-shape cross-sectional profile 16 of the glass fiber 11. In other implementations where the glass fiber 11 has the formation bulges 60 extending from the flat side 62 of the D-shaped portion 64 of the cross-sectional profile 16, the uncured coating 112 in the rotary coating die 110 proximate bulges 122 in the perimeter 118b of the die aperture 114 may have an increased viscosity to reduce the flow of the uncured coating 112 proximate the formation bulges 60 as it cures.

Referring again to FIG. 8, after the optical fiber 10 passes the curing device 134, the optical fiber 10 has the cured coating 22 and may be redirected from a first direction 160 (e.g., vertical) to a second direction 162 (e.g., horizontal) via a support 164 (e.g., a pulley or air bearing). After the support 164, the optical fiber 10 is pulled via a tensioner 166. The tensioner 166 applies tension to the optical fiber 10 to pull the glass fiber 11 from the draw furnace 102 and through the production system 100 generally. Finally, the coated optical fiber 10 may be coiled on a spool 168. Before being coiled on the spool 168, the optical fiber 10 may be color coated, printed on for information, or have an orientation mark printed thereon.

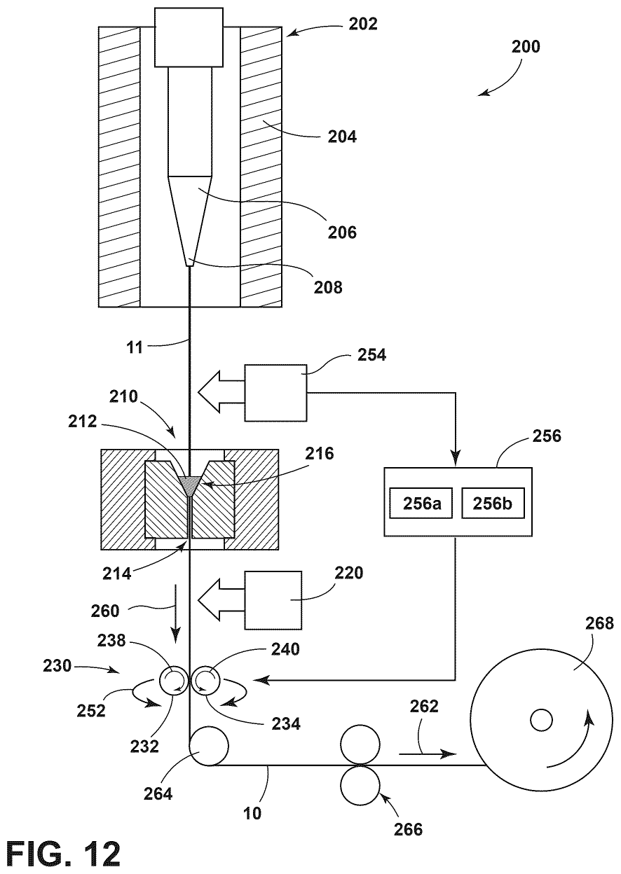

Referring to FIG. 12, a second implementation of a production system 200 for producing the non-circular optical fiber 10 is illustrated. The production system 200, similar to the first production system 100, may include a draw furnace 202 that includes a heating element 204 and a preform 206 disposed substantially vertical within the heating element 204. The optical fiber 10 may be drawn from a root 208 of the heated preform 206 in the form of the glass fiber 11 (i.e., the optical fiber 10 without the coating 22).

Referring still to FIG. 12, the production system 200 may further include a coating die 210 configured to coat the glass fiber 11. The coating die 210 is configured to coat the glass fiber 11 with an uncured coating 212 to form the optical fiber 10. The coating die 110 includes a die aperture 214 configured to apply the uncured coating 212 having a circular diameter at an initial thickness, T1, to the glass fiber 11. The coating die 210 includes a coating funnel structure 216 configured to pool the uncured coating 212 above the die aperture 214. The glass fiber 11 is pulled through the pooled uncured coating 212 to coat the glass fiber 11. Unlike the first implementation of the production system 100, the coating die 210 of the second production system 200 is static or substantially static and does not rotate to align with the glass fiber 11 as it is drawn from the preform 206.

Once the glass fiber 11 is coated in the uncured coating 212, the glass fiber 11 passes a curing device 220 to initiate the curing of the uncured coating 212. In some implementations, the curing device 220 is an ultraviolet light and the uncured coating 212 is UV light reactive (i.e., including a photo-initiator). In other implementations, the curing device 220 may be a light and the uncured coating 212 is light reactive. Once the glass fiber 11 passes the curing device 220 the uncured coating 212 begins to cure and form the coating 22 of the optical fiber 10. During the curing process, the uncured coating 212 may be manipulated to form the alignment plane 24.

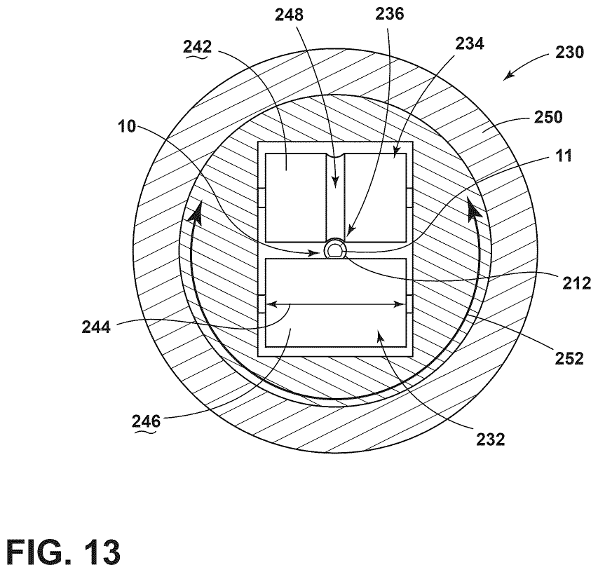

Referring to FIGS. 12 and 13, the glass fiber 11 with the uncured coating 212 may pass through a rotary die 230 configured to form the alignment plane 24. The uncured coating 212 may begin the curing process before entering the rotary die 230 to allow for the uncured coating 212 to be mostly or completely cured to form the coating 22 upon exiting the rotary die 230. The rotary die 230 includes a first forming roller 232 and a second forming roller 234. The forming rollers 232, 234 of the rotary die 230 are configured to counter-rotate toward a forming gap 236 defined by the forming rollers 232, 234. The first forming roller 232 generally rotates in a first direction 238 and the second forming roller 234 rotates in a second direction 240. The rotating forming rollers 232, 234 may assist in pulling the optical fiber 10 through the production system 200.

As illustrated in FIG. 13, the first forming roller 232 may include a planar forming surface 242 extending a width 244 of the roller 232. The second forming roller 234 may include a forming surface 246 having a recessed portion 248. As the glass fiber 11 with the uncured or partially cured coating 212 passes through the formation gap 236, a portion of the glass fiber 11 is received in the recessed portion 248 of the second forming roller 234. The portion of the partially cured coating 212 received within the recessed portion 248 is not deformed or only partially deformed. The portion of the partially cured coating 212 received within the recessed portion 248 directly opposes a portion of the partially cured coating 212 that is formed as the alignment plane 24. The planar forming surface 242 forms the alignment plane 24 by compressing or deforming the partially cured coating 212 to be a flat alignment plane 24.

It is contemplated that either the first or the second forming rollers 232, 234 may form the alignment plane 24. It is also contemplated that the recessed portion 248 may be squared, as illustrated, or rounded, or any other shape to form varied shapes of the coating 22. Additionally, each of the formation rollers 232, 234 may have planar forming surfaces so opposing sides of the optical fiber 10 have flat surfaces. It is further contemplated that the forming surfaces 242, 246 that form the alignment plane 24 may include a recessed portion to form a flat surface or other contoured surface by reducing the gap between the forming rollers 232, 234.

In order to form the alignment plane 24 proximate to the alignment region 18 of the glass fiber 11, the alignment region 18 is aligned with the first forming roller 232 with the planar forming surface 242. During the draw process, the glass fiber 11 may not be rotationally aligned with the forming gap 236 to form the alignment plane 24. To correct for misalignment, the rotary die 230 is operably coupled to a motor 250 or an actuator 250 to rotate the forming gap 236 around an axis defined by the glass fiber 11 traveling therethrough, as shown by arrow 252. A fiber rotation measurement sensor 254, which may be an optical sensor, an infrared light sensor or other sensor, is configured to sense the rotational location of the alignment region 18 of the glass fiber 11. The fiber rotation measurement sensor 254 is communicatively coupled to a controller 256. The controller 256 is communicatively coupled to the rotary die 230. Using the input of the fiber rotation measurement sensor 254 and rotational position of the forming gap 236, the controller 256 activates the actuator 250 to rotate the forming gap 236 to align the glass fiber 11 with the forming gap 236 as it is drawn therethrough. The rotational position of the forming gap 236 may be determined by positional variation based on inputs by the actuator 250 and a known zero position, a position sensor, or other method configured to determine the rotational position of the forming gap 236.

The controller 256 may include a microprocessor or a processor 256a and a memory 256b. The memory 256b may store instructions executable by the processor 256a. It is contemplated that any digital and/or analog processing circuitry and memory storage medium may be employed. The controller 256 may be coupled to display or other human machine interface (HMI) for a user to view position data or other operational data of the rotary die 230 or the production system 200.

Referring again to FIG. 12, after the optical fiber 10 passes through the rotatory die 230, the optical fiber 10 has the cured coating 22 and may be redirected from a first direction 260 (e.g., vertical) to a second direction 262 (e.g., horizontal) via a support 264. After the support 264, the optical fiber 10 is pulled via a tensioner 266. The tensioner 266 applies tension to the optical fiber 10 to pull the glass fiber 11 from the draw furnace 202 and through the production system 200 generally. Finally, the coated optical fiber 10 may be coiled on a spool 268. Before being coiled on the spool 268, the optical fiber 10 may be color coated, printed on for information, or have an orientation mark printed thereon.

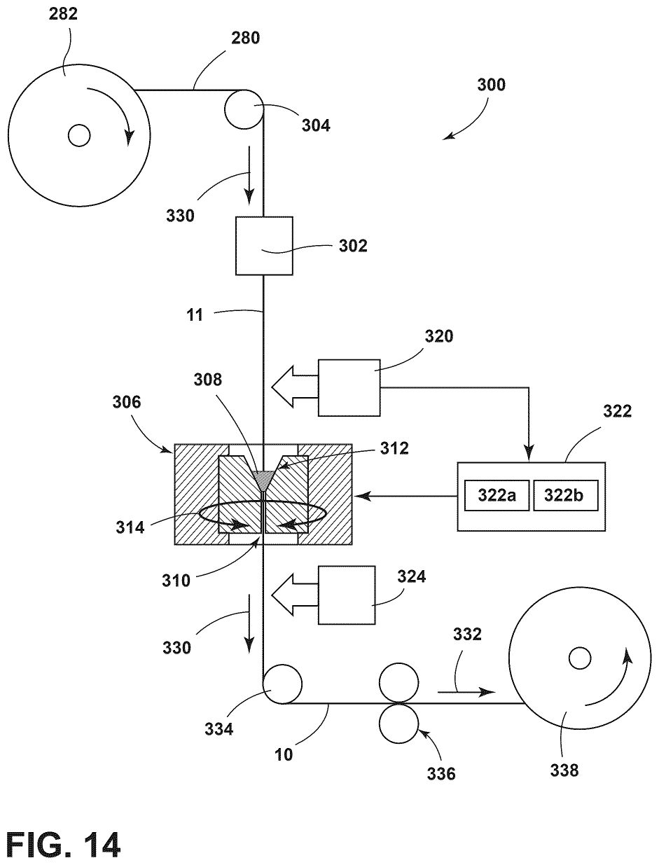

Referring to FIGS. 14-17, the non-circular optical fiber 10 may be formed from a source optical fiber 280 or a stock optical fiber 280 having a circular outer coating with a core having an alignment region 18. The stock optical fiber 280 may be coiled on a feed spool 282 and used to form the non-circular optical fiber 10. The stock optical fiber 280 may be formed using a traditional fiber draw system, a process similar to those discussed with reference to production systems 100, 200 without the formation of the alignment plane 24 (e.g., using the rotary coating die 110 or the rotary die 230). The stock optical fiber 280 may include the glass fiber 11 with the cross-sectional profile 16 having the alignment region 18 and have an outer coating with a circular or substantially circular cross-sectional profile 16. It is contemplated that the stock optical fiber 280 may be formed with either of the production systems 100, 200 and include the alignment plane 24. In such implementations the second processing step may be used to form a flat alignment plane 24 or remove excess coating 22.

Referring to FIG. 14, a first formation system 300 includes the feed spool 282 with the stock optical fiber 280. The stock optical fiber 280 is unwound from the feed spool 282 and is guided to a fiber coating striper 302 using a support 304. The fiber coating striper 302 is configured to remove the circular coating of the stock optical fiber 280 and provide the glass fiber 11 without a coating. The first formation system 300 is similar to the first production system 100 once the coating is removed from the stock optical fiber 280. The glass fiber 11 then passes through a rotary coating die 306, which operates similar to the rotary coating die 110 discussed with reference to FIGS. 8-11B. The rotary coating die 306 is configured to coat the glass fiber 11 with an uncured coating 308 to form the optical fiber 10. The rotary coating die 306 includes a die aperture 310 configured to apply the uncured coating 308 at a desired or initial thickness, T1, to the glass fiber 11. The rotary coating die 306 includes a coating funnel structure 312 configured to pool the uncured coating 308 above the die aperture 310. The glass fiber 11 is pulled through the pooled uncured coating 308. The die aperture 310 has a perimeter to form the uncured coating layer 308 having the initial thickness T1 and the initial coating perimeter 120, as discussed about with to FIGS. 8-11B.

During the feed process from the feed spool 282, the glass fiber 11 may not be rotationally aligned with the die aperture 310. To correct for misalignment, the rotary coating die 306 is operably coupled to a motor or actuator to rotate, as shown by arrow 314, the die aperture 310 around an axis defined by the glass fiber 11 traveling therethrough. A fiber rotation measurement sensor 320, which may be an optical sensor, an infrared light sensor or other sensor, is configured to sense the rotational location of the alignment region 18 of the glass fiber 11. The fiber rotation measurement sensor 320 is communicatively coupled to a controller 322. The controller 322 is also communicatively coupled to the rotary coating die 306. Using the input of the fiber rotation measurement sensor 320 and rotational position of the die aperture 310, the controller 322 activates the actuator to rotate the die aperture 310 to align the glass fiber 11 with the aperture 310 as it is drawn therethrough. The rotational position of the die aperture 310 may be determined by positional variation based on inputs by the actuator and a known zero position, a position sensor, or other method configured to determine the rotational position of the die aperture 310.

The controller 322 may include a microprocessor or a processor 322a and a memory 132b. The memory 322b may store instructions executable by the processor 322a. It is contemplated that any digital and/or analog processing circuitry and memory storage medium may be employed. The controller 322 may be coupled to display or other human machine interface (HMI) for a user to view position data or other operational information of the rotary coating die 306 or of the formation system 300.

Referring still to FIG. 14, once the glass fiber 11 passes through the rotary coating die 306, the glass fiber 11 with the uncured coating 308 passes a curing device 324. In some implementations, the curing device 324 is an ultraviolet light and the uncured coating 308 is UV light reactive (i.e., including a photoinitiator). In other implementations, the curing device may be a light and the uncured coating 308 is light reactive. The uncured coating 308 deforms similar to that discussed with reference to FIGS. 10A-11B and similar considerations apply to the structure of the glass fiber 11, the viscosity of the uncured coating 308 and other variables.

After the optical fiber 10 passes the curing device 324, the optical 10 has the cured coating 22 and may be redirected from a first direction 330 (e.g., vertical) to a second direction 332 (e.g., horizontal) via a support 334. After the support 334, the optical fiber 10 is pulled via a tensioner 336. The tensioner 336 applies tension to the optical fiber 10 to pull to assist in pulling the glass fiber 11 from the feed spool 282 and through the formation system 300 generally. Finally, the coated optical fiber 10 may be coiled on a spool 338. Before being coiled on the spool 338, the optical fiber 10 may be color coated, printed on for information, or have an orientation mark printed thereon.

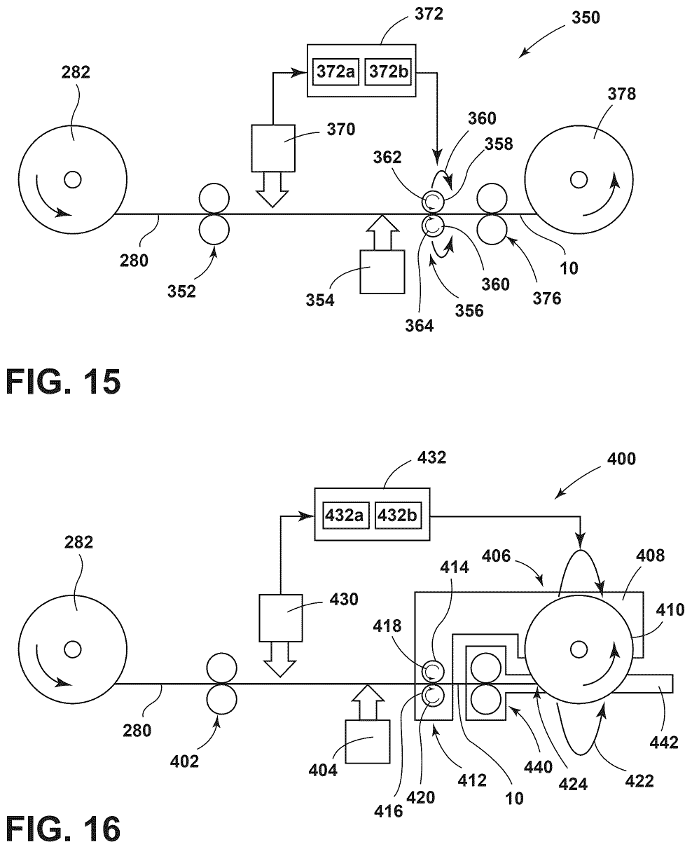

Referring to FIG. 15, a second formation system 350 includes the feed spool 282 with the stock optical fiber 280. The stock optical fiber 280 is unwound from the feed spool 282 via a guide rollers 352. From the guide rollers 352, the stock optical fiber 280 passes a heater 354 to soften the coating of the stock optical fiber 280 to be workable or malleable. The malleable stock optical fiber 280 is then pulled through a rotary die 356 to from the alignment plane 24. It is contemplated that the stock optical fiber 280 has a coating that is malleable without heating. The rotary die 356 is similar to the rotary die 230 discussed with reference to FIGS. 12 and 13. The rotary die 356 includes a first forming roller 358 and a second forming roller 360. The forming rollers 358, 360 of the rotary die 356 are configured to counter-rotate toward a forming gap defined by the forming rollers 358, 360. The first forming roller 358 generally rotates in a first direction 362 and the second forming roller 360 rotates in a second direction 364. The rotating forming rollers 358, 360 may assist in pulling the optical fiber 10 through the formation system 350. Each of the forming rollers 358, 360 may include formation surfaces similar to the rotary die 230 discussed with refence to FIGS. 12 and 13.

During the feed process from the feed spool 282, the glass fiber 11 may not be rotationally aligned with the formation gap of the rotary die 356. To correct for misalignment, the rotary die 356 is operably coupled to a motor or an actuator to rotate, as shown by arrow 466, the forming gap around an axis define by the glass fiber 11 traveling therethrough. A fiber rotation measurement sensor 370, which may be an optical sensor, an infrared light sensor or other sensor, is configured to sense the rotational location of the alignment region 18 of the glass fiber 11, through the coating. The fiber rotation measurement sensor 370 is communicatively coupled to a controller 372. The controller 372 is also communicatively coupled to the rotary die 356. Using the input of the fiber rotation measurement sensor 370 and rotational position of the forming gap, the controller 372 activates the actuator to rotate the forming gap to align the glass fiber 11 with the forming gap as it is drawn therethrough. The rotational position of the forming gap may be determined by positional variation based on inputs by the actuator and a known zero position, a position sensor, or other method configured to determine the rotational position of the forming gap.

The controller 372 may include a microprocessor or a processor 372a and a memory 372b. The memory 372b may store instructions executable by the processor 372a. It is contemplated that any digital and/or analog processing circuitry and memory storage medium may be employed. The controller 372 may be coupled to display or other human machine interface (HMI) for a user to view position data or other operational data of the rotary die 356 or of the formation system 350.

Once the stock optical fiber 280 is pulled through the rotary die 356, the coating 22 cools to form the non-circular optical fiber 10. The rotary die 356 forms the coating without removing the original coating of the stock optical fiber 280. The optical fiber 10 is then pulled via a tensioner 376. The tensioner 376 applies tension to the optical fiber 10 to pull or assist in pulling the optical fiber 10 from the feed spool 282 and through the formation system 350 generally. Finally, the coated optical fiber 10 may be coiled on a spool 378. Before being coiled on the spool 378, the optical fiber 10 may be color coated, printed on for information, or have an orientation mark printed thereon.

Referring to FIG. 16, a third formation system 400 includes the feed spool 282 with the stock optical fiber 280. The stock optical fiber 280 is unwound from the feed spool 282 to guides 402, which directs the stock optical fiber 280 past a heater 404 to soften the coating of the stock optical fiber 280 to be workable or malleable. It is contemplated that the stock optical fiber 280 has a coating that is malleable without heating. The malleable stock optical fiber 280 is then guided to a rotary spool and die system 406. The rotary spool and die system 406 include a mount 408 coupled to a spool 410 for winding the completed optical fiber 10 and a die 412. The die 412 is configured to form the alignment plane 24 by deforming the coating of the stock optical fiber 280. In some implementations the coating of the stock optical fiber 280 may not need to be heated and can be formed by passing through the die 412 without heating.

The die 412 includes a first forming roller 414 and a second forming roller 416. The forming rollers 414, 360 of the die 412 are configured to counter-rotate toward a forming gap defined by the forming rollers 414, 416. The first forming roller 414 generally rotates in a first direction 418 and the second forming roller 416 rotates in a second direction 420. The rotating forming rollers 414, 416 may assist in pulling the optical fiber 10 through the formation system 400. Each of the forming rollers 414, 416 may include formation surfaces similar to the rotary die 230 discussed with refence to FIGS. 12 and 13.

During the feed process from the feed spool 282, the glass fiber 11 may not be rotationally aligned with the formation gap of the die 412. To correct for misalignment, the rotary spool and die system 406 is operably coupled to a motor or actuator to rotate, as shown by arrow 422, the forming gap of the die 412 and a feed point 424 of the spool 410 around an axis defined by the optical fiber 10. By rotating the die 412 and the spool 410 together, the optical fiber 10 may be aligned or substantially aligned on the spool such that the alignment plane 24 all are oriented the same or substantially the same. Once the stock optical fiber 280 is pulled through the die 412, the coating 22 cools to form the non-circular optical fiber 10.

A fiber rotation measurement sensor 430, which may be an optical sensor, an infrared light sensor or other sensor, is configured to sense the rotational location of the alignment region 18 of the glass fiber 11, through the coating. The fiber rotation measurement sensor 430 is communicatively coupled to a controller 432. The controller 432 is also communicatively coupled to rotary spool and die system 406. Using the input of the fiber rotation measurement sensor 430 and rotational position of the forming gap of the die 412, the controller 432 activates the actuator to rotate the forming gap to align the glass fiber 11 with the forming gap as it is drawn therethrough. The rotational position of the forming gap may be determined by positional variation based on inputs by the actuator and a known zero position, a position sensor, or other method configured to determine the rotational position of the forming gap.

The controller 432 may include a microprocessor or a processor 432a and a memory 432b. The memory 432b may store instructions executable by the processor 432a. It is contemplated that any digital and/or analog processing circuitry and memory storage medium may be employed. The controller 432 may be coupled to display or other human machine interface (HMI) for a user to view position data or other operational data of the rotary spool and die system 406 or of the formation system 400.

To prevent or reduce rotational movement of the stock optical fiber 280 between the die 412 and the feed spool 282, the optical fiber 10 is feed through a tensioner 440 that is static relative to the feed spool 282. The tensioner 440 applies tension to the optical fiber 10 to pull or assist in pulling the optical fiber 10 from the feed spool 282 and through the formation system 400 generally. The tensioner 440 may be mounted on a bracket 442 that is static relative to the feed spool 282. The optical fiber 10 passed through the tensioner 440 and is wound or spooled on the spool 410. Before being coiled on the spool 410, the optical fiber 10 may be color coated, printed on for information, or have an orientation mark printed thereon.

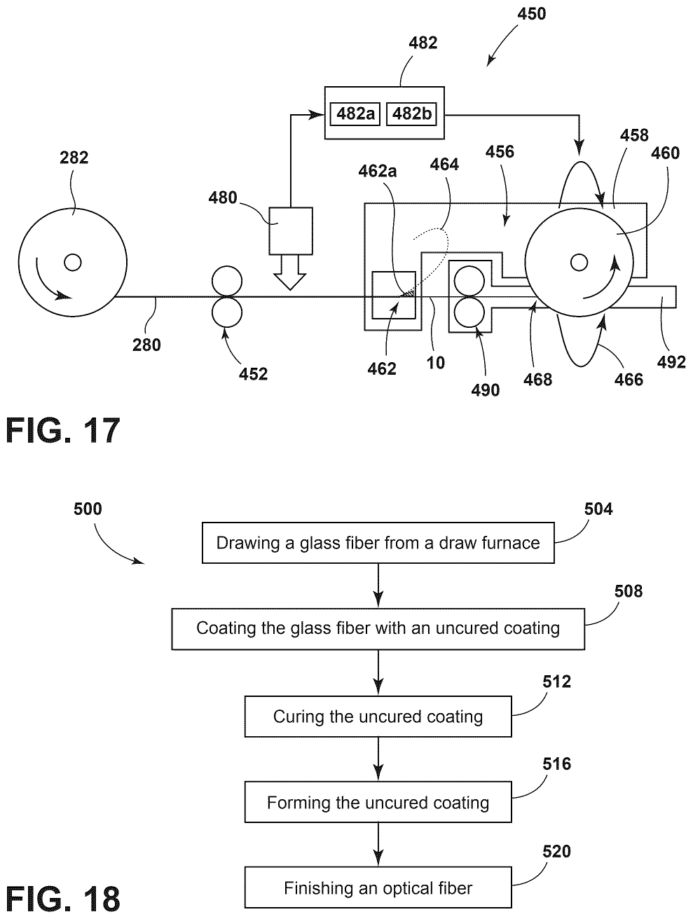

Referring to FIG. 17, a fourth formation system 450 includes the feed spool 282 with the stock optical fiber 280. The stock optical fiber 280 is unwound from the feed spool 282 to guides 402, which directs the stock optical fiber 280 to a rotary spool and coating removal system 456. The rotary spool and coating removal system 456 includes a mount 458 coupled to a spool 460 for winding the completed optical fiber 10 and a coating remover 462. The coating remover 462 generally removes excess coating 464 from the stock optical fiber 280 to form the alignment plane 24. The removal of the excess coating 464 generally forms a flat alignment plane 24 but may form an alignment plane 24 that extends from bulges in the coating 22. The coating remover 462 may be a mechanical cutter or laser ablation. As illustrated, the coating remover 462 includes a mechanical blade 462a to remove the excess coating 464. A heater may be included between the guides 452 and the rotary spool and coating removal system 456 to assist in the removal of the coating of the stock optical fiber 280. The excess coating 464 removed from the stock optical fiber 280 is proximate the alignment region 18 of the glass fiber 11.

During the feed process from the feed spool 282, the glass fiber 11 may not be rotationally aligned with the coating remover 462. To correct for misalignment, the rotary spool and coating removal system 456 is operably coupled to a motor or actuator to rotate, as shown by arrow 466, the coating remover 462 and a feed point 468 of the spool 460 around an axis defined by the optical fiber 10. By rotating the coating remover 462 and the spool 460 together, the optical fiber 10 may be aligned or substantially aligned on the spool such that the alignment plane 24 all are oriented the same or substantially the same. Once the stock optical fiber 280 is pulled through coating remover 462 the coating 22 is formed for the non-circular optical fiber 10.

A fiber rotation measurement sensor 480, which may be an optical sensor, an infrared light sensor or other sensor, is configured to sense the rotational location of the alignment region 18 of the glass fiber 11, through the coating. The fiber rotation measurement sensor 480 is communicatively coupled to a controller 482. The controller 482 is also communicatively coupled to rotary spool and coating removal system 456. Using the input of the fiber rotation measurement sensor 480 and rotational position of the coating remover 462, the controller 432 activates the actuator to rotate the coating remover 462 to align the glass fiber 11 with the coating remover 462 as it is drawn therethrough. The rotational position of the coating remover 462 may be determined by positional variation based on inputs by the actuator and a known zero position, a position sensor, or other method configured to determine the rotational position of the coating remover 462.

The controller 482 may include a microprocessor or a processor 482a and a memory 482b. The memory 482b may store instructions executable by the processor 482a. It is contemplated that any digital and/or analog processing circuitry and memory storage medium may be employed. The controller 482 may be coupled to display or other human machine interface (HMI) for a user to view position data or other operational data of rotary spool and coating removal system 456 or of the formation system 450.

To prevent or reduce rotational movement of the stock optical fiber 280 between the coating remover 462 and the feed spool 282, the optical fiber 10 is fed through a tensioner 490 that is static relative to the feed spool 282. The tensioner 490 applies tension to the optical fiber 10 to pull or assist in pulling the optical fiber 10 from the feed spool 282 and through the formation system 450 generally. The tensioner 490 may be mounted on a bracket 492 that is static relative to the feed spool 282. The optical fiber 10 passed through the tensioner 490 and is wound or spooled on the spool 460. Before being coiled on the spool 460, the optical fiber 10 may be color coated, printed on for information, or have an orientation mark printed thereon.

Referring to FIG. 18, and with reference to FIGS. 1-13, a flow chart for method 500 for producing the non-circular optical fiber 10 is illustrated. In step 504, the glass fiber 11 is drawn from the draw furnace 102, 202. The glass fiber 11 includes the core arrangement 14 and the cladding 12 having the cross-sectional profile 16 with the alignment region 18. In step 508, the glass fiber 11 is coated in the uncured coating 112, 212 using the coating die 110, 210. Step 508 may include sensing the location of the alignment region 18 of the glass fiber 11 using the fiber rotation sensor 130 and rotating the die aperture 114 to align the glass fiber 11 with die aperture 114. Step 508 may also include coating the glass fiber 11 in a circular coating using the coating die 210. In step 512, the uncured coating 112, 212 has the curing process initiated by passing or pulling the glass fiber 11 with the uncured coating 112, 212 passed the curing device 134, 220.

The method 500 may include step 516 of forming the uncured coating 212 into the coating 22 by pulling the glass fiber 11 with the uncured coating 112, 212 through the rotary die 230. Step 516 may include sensing the location of the alignment region 18 of the glass fiber 11 using the fiber rotation sensor 254 and rotating the forming gap 236 to align the glass fiber 11 with die aperture 114. The coating 22 of the formed optical fiber 10 will include the alignment plane 24 after passing through the forming gap 236. Step 520 may include painting, inking, spooling, or otherwise finishing the optical fiber 10.

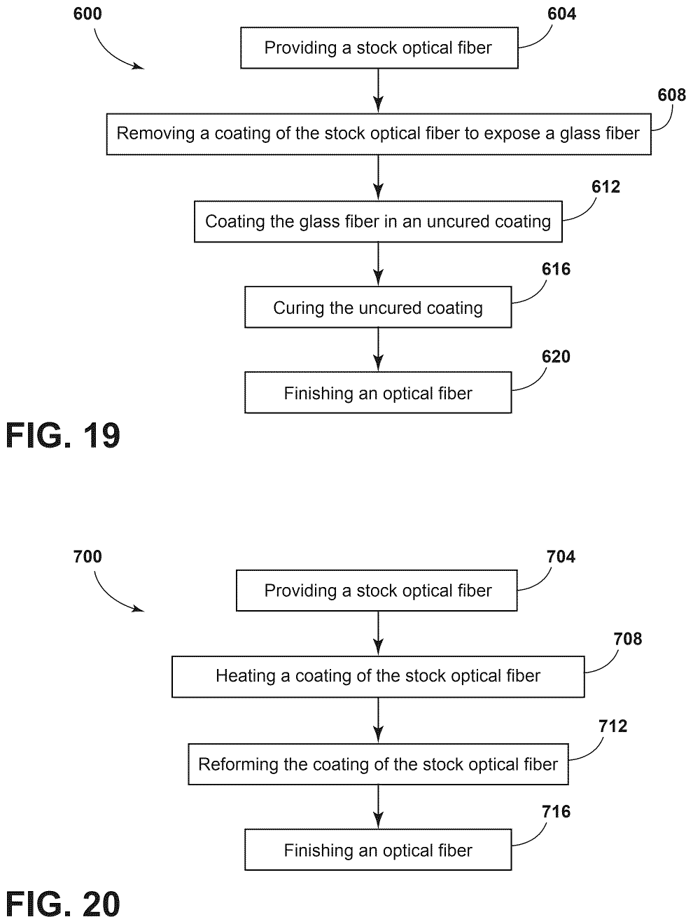

Referring to FIG. 19, and with reference to FIGS. 1-7, 9A, 9B, and 14, a flow chart for method 600 for producing the non-circular optical fiber 10 is illustrated. In step 604, the stock optical fiber 280 is provided on the stock spool 282. In step 608, the coating of the stock optical fiber 280 is stripped providing the glass fiber 11 with the alignment region 18. Step 612 may include pulling the glass fiber 11 through the rotary coating 306. Step 612 may include sensing the location of the alignment region 18 of the glass fiber 11 using the fiber rotation sensor 320 and rotating the die aperture 310 to align the glass fiber 11 with die aperture 310. The uncured coating 308 may have a perimeter including the alignment plane 24. In step 616 the uncured coating 308 has the curing process initiated by passing or pulling the glass fiber 11 with the uncured coating 308 passed the curing device 324. Step 620 may include painting, inking, spooling, or otherwise finishing the optical fiber 10. Step 620 may also include forming the uncured coating 308 similar to that discussed in method 500.

Referring to FIG. 20, and with reference to FIGS. 1-7, 13, and 15-17, a flow chart for method 700 for producing the non-circular optical fiber 10 is illustrated. In step 704, the stock optical fiber 280 is provided on the stock spool 282. In step 708, the coating of the stock optical fiber 280 may be heated to form a malleable coating on the stock optical fiber 280. In step 712, the coating of the stock optical fiber 280 is reformed to form the alignment plane 24 of the coating 22. The coating may be reformed using a die, which may be the rotary die 356 or the die 412 include in the rotary spool and die system 406, to form the optical fiber 10 with the alignment plane 24. Step 712 may include sensing the location of the alignment region 18 of the glass fiber 11 using the fiber rotation sensor 370, 430 and rotating the forming gap of the die 356, 412 to align the glass fiber 11 with the forming gap.

Step 712 may include removing a portion of the coating of the stock optical fiber 280 via the coating remover 462 to form the optical fiber 10 with the alignment plane 24. Step 712 may also include sensing the location of the alignment region 18 of the glass fiber 11 using the fiber rotation sensor 480 and rotating the coating remover 462 to align the glass fiber 11 with coating remover 462. Step 716 may include painting, inking, spooling, or otherwise finishing the optical fiber 10.

Use of the present device may provide a variety of advantages. For example, the alignment plane 24 of the optical fiber 10 allows for more efficient alignment of two optical fibers being coupled together. The alignment plane 24 may also assist in forming ribbons 70 of optical fibers 10 by providing for a plane for each of the fibers 10 to be aligned along. Further, the alignment region 18 of the optical fiber 10 provides for further alignment between optical fibers 10 being coupled together. The alignment region 18 allows for finer alignment between the optical fibers being coupled. Additionally, in implementations including the formation bulges 60 in the alignment region 18, the formation bulges 60 may assist in forming the alignment plane 24 by controlling or partially controlling the flow of the uncured coating 112, 212, 308 on the glass fiber 11 before curing into the coating 22. The formation bulges 60 may assist in forming a flat or substantially flat alignment plan 24, which increases efficiency of aligning two glass fibers 11 to be coupled together. Additional benefits or advantages may be realized and/or achieved.

It will be apparent to those skilled in the art that various modifications and variations can be made without departing from the spirit or scope of the claims.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A non-circular optical fiber, comprising:
a glass cladding having a cross-sectional profile, wherein the cross-sectional profile is non-circular and includes an alignment region having formation bulges, and wherein an alignment axis is defined by the formation bulges;
a core arrangement including at least one glass core; and
a coating coupled to and in direct contact with the glass cladding, wherein the coating defines an alignment plane along the alignment region of the glass cladding, and wherein an angle between the alignment plane and the alignment axis is less than or equal to about 15°.

2. The non-circular optical fiber of claim 1, wherein the core arrangement defines an orientation reference line, and wherein an angle between the orientation reference line and the alignment plane is less than or equal to about 15°.

3. The non-circular optical fiber of claim 1, wherein the angle between the alignment plane and the alignment axis is less than or equal to about 5°.

4. The non-circular optical fiber of claim 1, wherein the alignment plane and the alignment axis are parallel.

5. The non-circular optical fiber of claim 1, wherein the cross-sectional profile includes a D-shaped portion and the formation bulges extending from a flat side of the D-shaped portion.

6. The non-circular optical fiber of claim 5, wherein a distance the formation bulges extend from the flat side is greater than or equal to 5 μm and less than or equal to 25 μm.

7. The non-circular optical fiber of claim 5, wherein the formation bulges include a first formation bulge extending from a first end of the flat side and a second formation bulge extending from a second end of the flat side.

8. The non-circular optical fiber of claim 7, wherein a distance between the first formation bulge and the second formation bulge is greater than or equal to 30 μm and less than or equal to 80 μm.

9. A non-circular optical fiber, comprising:
a glass cladding having a cross-sectional profile, wherein the cross-sectional profile includes a D-shaped portion and formation bulges extending from a flat side of the D-shaped portion, and wherein an alignment axis extends tangentially to the formation bulges;
a core arrangement including at least one glass core; and
a coating coupled to and in direct contact with the glass cladding, wherein the coating defines an alignment plane, and wherein an angle between the alignment plane and the alignment axis is less than or equal to about 15°.

10. The non-circular optical fiber of claim 9, wherein the at least one glass core includes a plurality of glass cores.

11. The non-circular optical fiber of claim 9, wherein the formation bulges include a first formation bulge and second formation bulge, and wherein the first formation bulge extends from a first end of the flat side and the second formation bulge extends from a second end of the flat side.

12. The non-circular optical fiber of claim 11, wherein the first formation bulge is spaced from a first edge of the flat side and the second formation bulge is spaced from the second edge of the flat side, and wherein a distance the first formation bulge is spaced from the first edge is greater than or equal to 5 μm and less than or equal to 10 μm, and further wherein a distance the second formation bulge from the second edge is greater than or equal to 5 μm and less than or equal to 10 μm.

13. The non-circular optical fiber of claim 12, wherein a distance between the first formation bulge and the second formation bulge is greater than or equal to 10 μm and less than or equal to 70 μm.

14. The non-circular optical fiber of claim 11, wherein a distance the first formation bulge and the second formation bulge extend from the flat side is between about 5 μm and about 25 μm.

15. The non-circular optical fiber of claim 9, wherein the core arrangement defines an orientation reference line, and wherein an angle between the orientation reference line and the alignment plane is less than or equal to about 5°.

16. The non-circular optical fiber of claim 15, wherein the core arrangement includes stress rods, and further wherein the stress rods and the at least one glass core align with the orientation reference line.

17. A non-circular optical fiber, comprising:
a glass cladding having a cross-sectional profile, wherein the cross-sectional profile includes a D-shaped portion and formation bulges extending from a flat side of the D-shaped portion, and wherein an alignment axis extends tangentially to the formation bulges;
a core arrangement defining an orientation reference line; and
a coating coupled to and in direct contact with the glass cladding, wherein the coating defines an alignment plane, and wherein an angle between the alignment plane and the orientation reference line is less than or equal to about 15°.

18. The non-circular optical fiber of claim 17, wherein the core arrangement includes at least one of a hollow core, a plurality of glass cores, or a polarization maintaining glass core.

19. The non-circular optical fiber of claim 17, wherein an angle between the alignment plane and the alignment axis is less than or equal to about 5°.

20. The non-circular optical fiber of claim 17, wherein a ratio of a first distance the formation bulges extending from the flat side to a second distance between the formation bulges is between about 1:3 and about 1:7.
